(19) United States
(12) Patent Application Publication
(10) Pub. No.: US 2011/0036704 A1
(43) Pub. Date: Feb. 17, 2011

(54) PROCESS FOR REMOVAL OF ACRYLIC ACID FROM THE PRODUCT GAS MIXTURE OF A HETEROGENEOUSLY CATALYZED PARTIAL GAS PHASE OXIDATION OF AT LEAST ONE C3 PRECURSOR COMPOUND

(75) Inventors: Till BLUM, Kuantan (MY); Peter Zurowski, Landau (DE); Steffen Rissel, Kirchheim (DE); Sylke Haremza, Neckargemund (DE); Thorsten Friese, Mannheim (DE); Ulrich Jäger, Romerberg (DE); Volker Schliephake, Schifferstadt (DE); Klaus Joachim Müller-Engel, Stutensee (DE); Ulrich Hammon, Mannheim (DE); Frank Höfer, Bad Durkheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/827,161

(22) Filed: Jun. 30, 2010

Related U.S. Application Data
(60) Provisional application No. 61/298,232, filed on Jan. 26, 2010.
(60) Provisional application No. 61/222,127, filed on Jul. 1, 2009.

(30) Foreign Application Priority Data
Jul. 1, 2009 (DE) 102009027401.4
Jan. 26, 2010 (DE) 102010001228.9

(51) Int. Cl. B01D 3/34; B01D 3/06

(52) U.S. Cl. 203/31

(57) ABSTRACT

A process for removal of a crude acrylic acid from a product gas mixture which comprises glyoxal as a by-product from a heterogeneously catalyzed partial gas phase oxidation of at least one C₃ precursor compound, which comprises the absorption of the acrylic acid in a high-boiling absorbent and the rectificative workup of the resulting adsorbate, and in which absorbent present in the bottoms liquid withdrawn from the bottom space of the absorption column is distilled off in a distillation unit and recycled into the absorption, before high boilers which remain are discharged, and in which the glyoxal content of the crude acrylic acid is reduced by restricting the high boiler residence time in the distillation unit.

The present invention relates to a process for removal of acrylic acid from the product gas mixture of a heterogeneously catalyzed partial gas phase oxidation of at least one C₃ precursor compound to acrylic acid, said product gas mixture comprising, in addition to acrylic acid, steam and glyoxal, also low boilers, medium boilers, high boilers and uncondensables other than the aforementioned compounds as secondary constituents, in which
the product gas mixture is cooled in a direct cooler by direct cooling with a finely sprayed cooling liquid, which evaporates a portion of the cooling liquid,
the cooled product gas mixture together with evaporated and unevaporated cooling liquid is conducted into the bottom space of an absorption column, said bottom space being connected to the absorption space which is above it in the absorption column and has separating internals by a chimney tray K which is present between the two and has at least one chimney, from which
the cooled product gas mixture and evaporated cooling liquid flow through the at least one chimney of the chimney tray K into the absorption space and ascend therein in countercurrent to a high-boiling absorbent which descends therein, in the course of which adsorbate A comprising acrylic acid absorbed in the absorbent accumulates on the chimney tray K,
adsorbate A which comprises acrylic acid absorbed in the absorbent and accumulates on the chimney tray K is conducted therefrom out of the absorption column,
a portion of adsorbate A conducted out of the absorption column is fed to the bottom space of the absorption column to form a bottoms liquid present in the bottom space, and, optionally, another portion of the adsorbate A conducted out is cooled and recycled into the absorption column above the chimney tray K,
optionally, low boilers are stripped out of the remaining residual amount R^{A} of adsorbate A conducted out of the absorption column in a stripping unit to obtain an adsorbate A* depleted in low boilers,
the residual amount R^{A} of adsorbate A or the adsorbate A* is fed to a rectification column with a rectifying section and stripping section,
in the stripping section of the rectification column, the absorbent is enriched, and absorbent is conducted out of the stripping section with a proportion of acrylic acid of ≦1% by weight, and
in the rectifying section of the rectification column, the acrylic acid is enriched, and a crude acrylic acid with a proportion by weight of acrylic acid of ≧90% by weight is conducted out of the rectifying section,
bottoms liquid comprising absorbent is withdrawn from the bottom space of the absorption column, a portion of this withdrawn bottoms liquid is fed to the direct cooler as cooling liquid and the residual amount of this withdrawn bottoms liquid is fed to a distillation unit which comprises a distillation column and a circulation heat exchanger,
in the distillation column, the bottoms liquid fed to the distillation unit is separated by distillation into vapor in which the proportion by weight of absorbent is greater than the proportion by weight of absorbent in the bottoms liquid, and into liquid concentrate in which the proportion by weight of constituents B with higher boiling points than the absorbent (under distillation conditions) is greater than the proportion by weight of constituents B in the bottoms liquid,
a stream of the vapors, optionally after cooling and/or condensation thereof in an indirect heat exchanger, is recycled into the absorption column above the chimney tray K,
at the lower end of the distillation column, a stream M of the concentrate which accumulates there in liquid form at a level S is conducted out of the distillation column with the temperature T¹,
a substream T^{Au} of this stream M is discharged from the process for removal of acrylic acid from the product gas mixture, and
the residual stream R^{M} of the stream M is recycled into the distillation column via the circulation heat exchanger with the temperature T²≧T¹ above the withdrawal of the stream M from the distillation column.

Acrylic acid is an important monomer which finds use as such and/or in the form of its alkyl esters for production of polymers used in the hygiene sector (for example water-superadsorbing polymers) (cf., for example, WO 02/055469 and WO 03/078378).

Acrylic acid can be prepared, for example, by heterogeneously catalyzed partial oxidation of a C₃ precursor compound (e.g. propylene, propane, acrolein, propionaldehyde, propionic acid, propanol and/or glycerol) in the gas phase (cf., for example, EP-A 990 636, U.S. Pat. No. 5,108,578, EP-A 1 015 410, EP-A 1 484 303, EP-A 1 484 308, EP-A 1 484 309, US-A 2004/0242826 and WO 2006/136336).

In principle, in the course of such a heterogeneously catalyzed partial gas phase oxidation, pure acrylic acid is not obtained, but instead merely a product gas mixture which comprises acrylic acid and, in addition to acrylic acid, also comprises constituents other than acrylic acid, from which the acrylic acid has to be removed. Such a constituent other than acrylic acid in the product gas mixture will normally be steam. A reason for this is that steam firstly typically constitutes a by-product of the partial oxidation and secondly is regularly also used as an inert diluent gas in the partial oxidation reactions.

The nature and the particular proportion of the constituents other than acrylic acid in the product gas mixture of the partial oxidation of the C₃ precursor compound of acrylic acid can be influenced by parameters including the purity of the C₃ precursor compound used as the raw material and the reaction conditions (including the catalysts used) under which the heterogeneously catalyzed partial gas phase oxidation is performed (cf., for example, DE-A 101 31 297 and DE-A 10 2005 052 917). Typical of such secondary constituents other than acrylic acid and steam are, for example, carbon oxides (CO, CO₂), molecular nitrogen, molecular oxygen, low molecular weight alkanes such as propane, ethane and methane, lower saturated carboxylic acids such as formic acid, acetic acid and propionic acid, lower aldehydes such as formaldehyde, benzaldehyde and furfurals, and higher carboxylic acids or anhydrides thereof, such as benzoic acid, phthalic anhydride and maleic anhydride.

A portion of these secondary constituents other than acrylic acid and steam is, in its pure form at standard pressure (1 bar), less volatile than pure acrylic acid (has a boiling point lower than that of acrylic acid at standard pressure). In this document, these secondary constituents shall be referred to as low boilers when their boiling point at standard pressure is ≧0° C. and is at the same time at least 20° C. below the boiling point of acrylic acid (at standard pressure) (e.g. acetic acid).

When the boiling point of the aforementioned secondary constituents at standard pressure is <0° C., they will be encompassed in this document under the term “uncondensables”.

The uncondensable secondary constituents include especially secondary constituents such as molecular nitrogen which are much more volatile than water. Another portion of the secondary constituents is very much less volatile than acrylic acid (e.g. phthalic anhydride) and has a boiling point at standard pressure which is at least 75° C. above that of acrylic acid (at standard pressure). These secondary constituents are referred to in this document as high boilers. Secondary constituents such as maleic anhydride whose boiling points at standard pressure are <20° C. below and <75° C. above that (at standard pressure) of acrylic acid shall be referred to in this document as medium boilers.

For removal of acrylic acid from the product gas mixture of a heterogeneously catalyzed partial gas phase oxidation of at least one C₃ precursor compound, various processes are known in the prior art.

One of these removal processes is the procedure detailed in the preamble of this document. It is described, for example, in documents DE-A 103 36 386, DE-A 196 27 850, DE-A 024 49 780 and EP-A 925 272, and the prior art acknowledged in these documents. The supply of the bottoms liquid withdrawn from the bottom space of the absorption column to the distillation unit comprising a distillation column and a circulation heat exchanger is for the purpose of recovering absorbent present in the bottoms liquid, before undesired high-boiling by-products (which also comprise high-boiling secondary constituents) are discharged as a constituent of the substream T^{Au} from the process for removal of acrylic acid (cf., for example, DE-A 24 49 780). These by-products to be discharged from the removal process include, for example, also polymers of acrylic acid which form in an unavoidable manner only in the course of the performance of the removal process, and resinified cracking products of the absorbent, but also polymerization inhibitors and any catalyst dust present in the product gas mixture of the partial oxidation (the boiling point of these high-boiling secondary constituents is (both at standard pressure and under the conditions of the distillation) typically above that of the absorbent; in this document, these high-boiling secondary constituents are also referred to as constituents B). It is characteristic of this procedure that the acrylic acid is removed from the adsorbate comprising it in dissolved form essentially in the rectifying section of a rectification column in the form of a crude acrylic acid whose proportion by weight of acrylic acid is ≧90% by weight. Frequently, the proportion by weight of such crude acrylic acid is even ≧95% by weight or ≧98% by weight. In general, the proportion by weight of aforementioned crude acrylic acid will, however, be ≦99.9% by weight, in many cases ≦99.8% by weight and often even ≦99.7% by weight.

For numerous end uses, however, aforementioned purities of crude acrylic acid are insufficient (cf., for example, EP-A 770 592). While numerous prior art documents promote crystallizative further purification of crude acrylic acid for various reasons (for example, EP-A 1 272 453, DE-A 196 06 877 and German application 10 2008 041 573.1), a rectificative further purification of crude acrylic acid to give pure acrylic acid is installed in many existing industrial scale production plants for reasons of historical process development (cf. DE-A 101 38 150).

It has already been described at the outset of this document, and is already known from EP-A 770 592, that the product gas mixture of a heterogeneously catalyzed partial gas phase oxidation of at least one C₃ precursor compound to acrylic acid may comprise, among other constituents, various aldehydes as constituents other than acrylic acid. It is also known from EP-A 770 592 that very small amounts of aldehydic impurities present in acrylic acid significantly increase the tendency of acrylic acid to undesired free-radical polymerization. EP-A 770 592, DE-A 101 38 150 and DE-A 101 38 150 therefore recommend adding aldehyde scavengers to the particular acrylic acid prior to the rectification thereof in the case of rectification of such an acrylic acid comprising aldehydic impurities (for example a crude acrylic acid).

However, the additional requirement therefor simultaneously accounts for the disadvantageousness of this procedure.

EP-A 1 298 120 discloses that one possible by-product of a heterogeneously catalyzed partial gas phase oxidation of C₃ precursors to acrylic acid which can be formed under particular conditions is the aldehyde glyoxal.

Because glyoxal promotes the undesired free-radical polymerization of acrylic acid, among other reasons, EP-A 1 298 120 recommends configuring the heterogeneously catalyzed partial gas phase oxidation of at least one C₃ precursor compound to acrylic acid in such a way that glyoxal by-product formation is minimized. One possible source for such glyoxal by-product formation in the course of a heterogeneously catalyzed partial gas phase oxidation of at least one C₃ precursor compound of acrylic acid to acrylic acid identified by EP-A 1 298 120 is the C₂ impurity ethylene which is frequently present in the C₃ precursor. In principle, possible sources are, however, also other impurities in the C₃ precursor compound used. Examples include those from which ethylene is only formed in the course of the heterogeneously catalyzed partial gas phase oxidation. EP-A 1 298 120 recommends, in a corresponding manner, the integration of processes for the purpose of removing such impurities. A disadvantage of this recommendation is the additional requirement for such removal processes.

DE-A 10 2008 040 799 discloses that the ability of glyoxal, as an impurity in acrylic acid, to promote the tendency of the acrylic acid to undesired free-radical polymerization, compared to other possible by-product aldehydes of a heterogeneously catalyzed partial gas phase oxidation of C₃ precursor compounds (for example acetaldehyde, formaldehyde, propionaldehyde, benzaldehyde, butyraldehyde, acrolein and furfural), based on equal molar impurity contents, is very much more marked. This is attributed in DE-A 10 2008 040 799 to the fact that the thermal expenditure for splitting of monomeric glyoxal into two formyl radicals is firstly particularly low, and the resulting formyl radicals are secondly particularly reactive.

For the above reason, glyoxal shall be assigned a special role in this document, and glyoxal shall be encompassed under none of the terms low boilers, medium boilers and high boilers, nor under the term uncondensables.

In-house studies by the applicant have shown that, when the product gas mixture of a heterogeneously catalyzed partial gas phase oxidation of at least one C₃ precursor compound to acrylic acid, in addition to acrylic acid, steam and low boilers, medium boilers, high boilers and uncondensables other than the aforementioned compounds, also comprises glyoxal, and a process according to the preamble of this document for the purpose of removing the acrylic acid from the product gas mixture of the partial oxidation is applied to this product gas mixture, the crude acrylic acid removed generally still also comprises glyoxal in analytically detectable amounts. This is found to be disadvantageous for the reasons already mentioned, both in the rectificative removal of the crude acrylic acid itself and in the case of rectificative further purification thereof. In the case of a crystallizative further purification of such a crude acrylic acid too, the adverse effect of the glyoxal would still be noticeable.

In view of these facts, it was an object of the present invention to provide a process for removal of acrylic acid according to the preamble of this document, which still has the disadvantage described to a reduced degree at most, without necessarily requiring, for that purpose, an additional use of specific chemical compounds and/or apparatuses.

Accordingly, a process is provided for removal of acrylic acid from the product gas mixture of a heterogeneously catalyzed partial gas phase oxidation of at least one C₃ precursor compound to acrylic acid, said product gas mixture comprising, in addition to acrylic acid, steam and glyoxal, also low boilers, medium boilers, high boilers and uncondensables other than the aforementioned compounds as secondary constituents and in which (i.e. which comprises the following process steps)
the product gas mixture is cooled in a direct cooler by direct cooling with a finely sprayed cooling liquid, which evaporates a portion of the cooling liquid,
the cooled product gas mixture together with evaporated and unevaporated cooling liquid is conducted into the bottom space of an absorption column, said bottom space being connected to the absorption space which is above it in the absorption column and has separating internals by a chimney tray K which is present between the two and has at least one chimney, from which
the cooled product gas mixture and evaporated cooling liquid flow through the at least one chimney of the chimney tray K into the absorption space and ascend therein in countercurrent to a high-boiling absorbent which descends therein, in the course of which adsorbate A comprising acrylic acid absorbed in the absorbent accumulates on the chimney tray K,
adsorbate A which comprises acrylic acid absorbed in the absorbent and accumulates on the chimney tray K is conducted therefrom out of the absorption column,
a portion of adsorbate A conducted out of the absorption column is fed to the bottom space of the absorption column to form a bottoms liquid present in the bottom space, and, optionally, another portion of the adsorbate A conducted out is cooled and recycled into the absorption column above the chimney tray K,
optionally, low boilers are stripped out of the remaining residual amount R^{A} of adsorbate A conducted out of the absorption column in a stripping unit to obtain an adsorbate A* depleted in low boilers,
the residual amount R^{A} of adsorbate A or the adsorbate A* is fed to a rectification column with a rectifying section and stripping section,
in the stripping section of the rectification column, the absorbent is enriched, and absorbent is conducted out of the stripping section with a proportion of acrylic acid of ≦1% by weight, and
in the rectifying section of the rectification column, the acrylic acid is enriched, and a crude acrylic acid with a proportion by weight of acrylic acid of ≧90% by weight is conducted out of the rectifying section,
bottoms liquid comprising absorbent is withdrawn from the bottom space of the absorption column, a portion of this withdrawn bottoms liquid is fed to the direct cooler as cooling liquid and the residual amount of this withdrawn bottoms liquid is fed to a distillation unit which comprises a distillation column and a circulation heat exchanger,
in the distillation column, the bottoms liquid fed to the distillation column is separated by distillation into vapor in which the proportion by weight of absorbent is greater than the proportion by weight of absorbent in the bottoms liquid, and into liquid concentrate in which the proportion by weight of constituents B with higher boiling points than the absorbent (under distillation conditions) is greater than the proportion by weight of constituents B in the bottoms liquid,
a stream of the vapors, optionally after cooling and/or condensation thereof (performed) in an indirect heat exchanger, is recycled into the absorption column above the chimney tray K,
at the lower end of the distillation column, a stream M of the concentrate which accumulates there in liquid form at a level S is conducted out of the distillation column with the temperature T¹,
a substream T^{Au} of this stream M is discharged from the process for removal of acrylic acid from the product gas mixture, and
the residual stream R^{M} of the stream M is recycled into the distillation column via the circulation heat exchanger with the temperature T²≧T¹ above the withdrawal of the stream M from the distillation column,
   wherein the mean residence time t^{V} of the constituents of the partial stream T^{Au} in the distillation unit is ≦40 h.

The reason for the successful application of the present invention probably results from the connection which follows.

As the result of reaction with secondary constituents having hydroxyl groups (for example H₂O, alcohols such as ethanol etc.), glyoxal is capable of forming hemiacetals and/or acetals. The boiling point thereof is normally comparatively elevated. In addition, such hemiacetals and/or acetals have the polymerization-promoting action for acrylic acid which is typical of monomeric glyoxal at worst to a significantly lesser degree than the latter, if at all.

However, for some hemiacetals or acetals of glyoxal, the formation reaction is a markedly reversible reaction, which is why monomeric glyoxal reforms again from these hemiacetals or acetals, for example under the action of elevated temperature, and then promotes undesired free-radical polymerization in a manner known per se.

In the case of water as a secondary constituent comprising hydroxyl groups, for example, the following, markedly reversible, acetal formation reactions are known (in this case, reference is also made to hydrates of glyoxal):

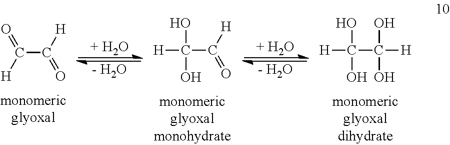

The terminology “monomeric” glyoxal monohydrate and “monomeric” glyoxal dihydrate is used for the purpose of delimiting the terms from “polyglyoxal” and “oligoglyoxal” hydrates (cf. also DE-A 10 2008 040 799 and German application 102008041573.1). They are probably formed via the monomeric glyoxal hydrates as intermediates.

The bottoms liquid which is withdrawn from the bottom space of the absorption column in the process according to the invention and which is fed to the distillation unit comprising a distillation column and a circulation heat exchanger thus regularly comprises hemiacetals and/or acetals (including the hydrates) of glyoxal. The longer the mean residence time t^{V} in the distillation unit under the given conditions is, the more monomeric glyoxal is reformed from the hemiacetals and/or acetals in the distillation unit and is recycled into the absorption column as a constituent of the vapor stream. This results ultimately in an elevated proportion of glyoxal constituents in the adsorbate A and in the end in an elevated glyoxal content in the crude acrylic acid removed. Conversely, a restriction of t^{V} leads to a reduction in the glyoxal content of the crude acrylic acid (based on the molar amount of acrylic acid present therein) and hence to the achievement of the object of the invention.

Preferably in accordance with the invention, t^{V} is ≦35 h, advantageously ≦30 h, more preferably ≦25 h. Depending on the boiling point of the absorbent, t^{V} will, however, generally be ≧10 h and in some cases ≧15 h.

The lower the boiling point of the absorbent, the lower the t^{V} which can be selected, since a shorter residence time of the bottoms liquid fed to the distillation unit in the distillation unit is sufficient in order to accumulate the absorbent present in the bottoms liquid supplied in appropriate proportions in the vapor and to recycle it as a constituent thereof into the absorption column.

When it is stated in this document that a liquid phase P (for example crude acrylic acid), based on the molar amount of acrylic acid present therein, comprises X molar ppm of glyoxal, the unit “molar ppm” should be understood such that, when a particular amount of this liquid phase P comprises, for example, 1 mol of acrylic acid, X·10⁻⁶ mol of glyoxal are simultaneously present in the same amount of the same liquid phase P.

For the aforementioned reasons, the term “glyoxal” (as always in this document, unless stated otherwise) shall encompass not only monomeric glyoxal but also glyoxal chemically bound reversibly in the form of acetals and/or hemiacetals of glyoxal (more particularly, the term “glyoxal” in this document always also encompasses monomeric glyoxal monohydrate and monomeric glyoxal dihydrate).

To experimentally determine the molar amount of “glyoxal” present in a liquid phase P in such forms, the procedure in this document should preferably be as follows.

First, a derivatization solution D is prepared. To this end, 2.0 g of a 50% by weight solution of 2,4-dinitrophenylhydrazine (manufacturer: Aldrich, purity: ≧97%) are dissolved at a temperature of 25° C. in 62 ml of a 37.0% by weight aqueous hydrochloric acid (manufacturer: Aldrich, purity: ≧99.999%). The resulting solution is subsequently (likewise at a temperature of 25° C.) stirred into 335 g of distilled water. After stirring at 25° C. for 1 hour, the derivatization solution D is obtained by filtration as the resulting filtrate.

Then 1 g (if required, this amount can be increased in a corresponding manner) of the derivatization solution D is weighed into a screwtop bottle with a capacity of 10 ml. Subsequently, a sample of the liquid phase P, the amount of which is in the range from 0.15 to 2.0 g, is weighed into the screwtop bottle thus filled.

The entire contents of the screwtop bottle are then mixed by shaking and then left at a temperature of 25° C. for a period of 10 minutes. During this time, the corresponding hydrazone H of monomeric glyoxal forms from the monomeric glyoxal present in the screwtop bottle by chemical reaction with 2,4-dinitrophenylhydrazine. During this time, the 2,4-dinitrophenylhydrazine, however, also removes the monomeric glyoxal, in the form of the hydrazone H, bound reversibly in the hemiacetals and/or acetals of glyoxal which are present in the screwtop bottle and contain monomeric glyoxal bound reversibly therein (in contrast, there is essentially no corresponding removal of monomeric glyoxal from hemiacetals and/or acetals with essentially irreversible glyoxal formation).

Addition of 0.5 g of glacial acetic acid (manufacturer: Aldrich, purity: ≧99.8%) to the screwtop bottle subsequently freezes the hydrazone formation which has occurred. When the addition of acetic acid is accompanied by formation of solid precipitate, further acetic acid is added gradually in order to redissolve the precipitate formed (but the total amount of acetic acid added must not exceed 1.0 g). When the precipitate formed still has not gone into solution even on attainment of the limit (1.0 g) of the total amount of acetic acid addition allowed, 0.5 g of dimethyl phthalate is weighed in. If this too is incapable of dissolving the precipitate formed, the amount of dimethyl phthalate added is increased gradually in order to bring about this dissolution (but the total amount of dimethyl phthalate added must not exceed 1.0 g). If the precipitate formed still has not gone into solution even on attainment of the limit (1.0 g) of the total amount of dimethyl phthalate addition allowed, 2 g of a mixture G of 9 g of acetonitrile and 1 g of dimethyl phthalate are added. If this addition too is incapable of dissolving the precipitate, the amount of mixture G added is increased gradually in order to bring about this dissolution. Normally, the total amount of mixture G added in order to bring about the dissolution of the precipitate does not exceed 5 g (all above dissolution tests are carried out at 25° C.).

The solution of the hydrazone H obtained in the screwtop bottle as described is subsequently analyzed for its hydrazone content by means of HPLC (High Pressure Liquid Chromatography) using the following operating conditions (the molar amount thereof results directly in the molar amount of glyoxal present in the sample of the liquid phase P):
Chromatography column to be used: Waters Symmetry C18, 150×4.6 mm, 5 μm (from Waters Associates, Milford, Mass., USA);
Injection volume of the solution
to be analyzed: 50 μl (time t=0);
Temperature: 40° C.;
Eluent flow rate: 1.5 ml/min;
Analysis time: 17 min;
Equilibration time: 8 min;
Eluent: in the period t from >0 min to 15 min, a mixture of 30% by weight of acetonitrile, 50% by weight of water and 20% by weight of tetrahydrofuran (each HPLC grade);
   in the period from >15 min to 17 min, a mixture of 65% by weight of acetonitrile, 30% by weight of water and 5% by weight of tetrahydrofuran;
   in the period from >17 min to 25 min, a mixture of 30% by weight of acetonitrile, 50% by weight of water and 20% by weight of tetrahydrofuran (then the column is equilibrated and ready for use again for the next analysis).

The retention time of the glyoxal as the hydrazone H is 7.613 min under the above conditions.

The analysis is effected by means of monochromatic radiation of wavelength 365 nm. The analysis method employed is absorption spectroscopy.

The variation of the eluent over the elution time ensures an increased separating action (in general, the liquid phase P, as well as glyoxal, also comprises other by-product aldehydes and/or by-product ketones which form the particular corresponding hydrazone with 2,4-dinitrophenylhydrazine).

To calibrate the HPLC method, appropriately in application terms, a solution of monomeric glyoxal in methanol will be used, which comprises 50 ppm by weight of monomeric glyoxal.

For this purpose, it is treated by means of the derivatization solution D as described above and then subjected to the HPLC analysis described.

One reason why the inventive procedure is advantageous is that (essentially without additional complexity) it also allows acrylic acid removals from the product gas mixtures which are relevant in accordance with the invention from a heterogeneously catalyzed partial gas phase oxidation of at least one C₃ precursor compound to acrylic acid to be managed in a satisfactory manner, in which the product gas mixture, based on the molar amount of acrylic acid present therein, comprises ≧1 molar ppm of glyoxal, or ≧5 molar ppm of glyoxal, or ≧10 molar ppm of glyoxal, or ≧20 molar ppm of glyoxal, or ≧50 molar ppm of glyoxal, or ≧100 molar ppm of glyoxal, or ≧150 molar ppm of glyoxal, or ≧200 molar ppm of glyoxal, or ≧300 molar ppm of glyoxal, or ≧400 molar ppm of glyoxal, or ≧500 molar ppm of glyoxal, or ≧750 molar ppm of glyoxal, or ≧1000 molar ppm of glyoxal, or ≧1250 molar ppm of glyoxal, or ≧1500 molar ppm of glyoxal. Normally, the aforementioned glyoxal contents of the product gas mixture (on the same basis) will be ≦5 mol %, in some cases also ≦3 mol % or ≦1 mol %. The term “glyoxal” or “glyoxal content” should, as always in this document (unless explicitly stated otherwise), be understood in the context of the definition of the term given in this document.

In other words, to determine the aforementioned glyoxal contents, based on the molar amount of acrylic acid present, in the product gas mixture, cooling the latter will convert at least the acrylic acid present therein, the hemiacetals and/or acetals of glyoxal present therein and the monomeric glyoxal present therein to the condensed phase, which will subsequently be analyzed as soon as possible after the generation thereof, as described above for a liquid phase P, for its content of glyoxal and of acrylic acid. The acrylic acid content can be determined in a manner known per se by chromatography (for example gas chromatography or by means of HPLC (high pressure liquid chromatography)).

One advantage of the process according to the invention is thus that it is not reliant on the use of high-purity C₃ precursor compounds of acrylic acid for the heterogeneously catalyzed partial gas phase oxidation to prepare acrylic acid.

For example, for the heterogeneously catalyzed partial gas phase oxidation to prepare acrylic acid, it is possible to use a starting reaction gas mixture which, based on the molar amount of the at least one C₃ precursor compound (e.g. propane, propylene, acrolein, propionic acid, propionaldehyde, propanol and/or glycerol) present therein, contains a molar total amount of C₂ compounds (e.g. ethane, ethylene, acetylene, acetaldehyde, acetic acid and/or ethanol) of ≧1 molar ppm, or ≧5 molar ppm, or ≧10 molar ppm, or ≧20 molar ppm, or ≧50 molar ppm, or ≧150 molar ppm, or ≧200 molar ppm, or ≧250 molar ppm, or ≧300 molar ppm, or ≧400 molar ppm, or ≧500 molar ppm, or ≧750 molar ppm, or ≧1000 molar ppm, or ≧1250 molar ppm, or ≧1500 molar ppm.

The starting reaction gas mixture is that gas mixture which is supplied to the catalyst bed for the purpose of partial oxidation of the C₃ precursor compound present therein to acrylic acid. As well as the C₃ precursor compound, undesired impurities and molecular oxygen as the oxidizing agent, the starting reaction gas mixture generally also comprises inert diluent gases, for example N₂, CO₂, H₂O, noble gas, molecular hydrogen, etc. Any inert diluent gas is normally such that it remains unchanged to an extent of at least 95 mol %, or better to an extent of at least 98 mol %, of its starting amount in the course of the heterogeneously catalyzed partial oxidation.

The proportion of the C₃ precursor compound in the starting reaction gas mixture may, for example, be in the range from 4 to 20% by volume, or from 5 to 15% by volume, or from 6 to 12% by volume.

Normally, the starting reaction gas mixture comprises, based on the stoichiometry of the partial oxidation reaction of the C₃ precursor compound to acrylic acid, an excess of molecular oxygen, in order to reoxidize the generally oxidic catalysts again.

In the case of subsequent application of the inventive procedure, this excess can be selected at a particularly high level, since an increasing oxygen excess is generally also accompanied by an increase in undesired secondary component formation of glyoxal.

In the same way, in the heterogeneously catalyzed partial gas phase oxidation of the C₃ precursor compound to acrylic acid, the maximum reaction temperature present in the catalyst bed can be selected at a comparatively elevated level when the process according to the invention is employed after the partial oxidation. One reason for this is that an increasing maximum temperature is generally also accompanied by an increase in the undesired secondary component formation of glyoxal. However, the employment of elevated maximum temperatures generally permits the use of catalysts with lower activity, which, for example, opens up the possibility of prolonged catalyst service life. However, in the case of use of catalysts with lower activity with increasing conversion of the C₃ precursor compound, undesired full combustion thereof frequently also proceeds to an increasing degree. Glyoxal may in some cases likewise be formed as an intermediate.

In the context of the inventive procedure, it is similarly also possible to proceed in a more generous manner in the selection of the loading (l(STP)/h·l) of the catalyst bed with the C₃ precursor compound (I.e. greater loadings do not present any difficulties). In addition, it has been found that the by-production of glyoxal is promoted by elevated water vapor contents in the reaction gas mixture. The process according to the invention is therefore of relevance not least when the starting reaction gas mixture used for the heterogeneously catalyzed partial gas phase oxidation of the C₃ precursor compound comprises ≧1% by weight, or ≧2% by weight, or ≧3% by weight, or ≧4% by weight, or ≧5% by weight, or ≧7% by weight, or ≧9% by weight, or ≧15% by weight, or ≧20% by weight of water vapor. In general, the water vapor content of the starting reaction gas mixture will, however, not be more than 40% by weight, frequently not more than 30% by weight. It will be appreciated that aforementioned water vapor contents also promote the formation of glyoxal hydrates, which is described in this document.

Otherwise, the process for heterogeneously catalyzed partial gas phase oxidation for preparing acrylic acid can be carried out in a manner known per se as described in the prior art.

When the C₃ precursor compound is, for example, propylene and/or acrolein, the heterogeneously catalyzed partial gas phase oxidation can be carried out, for example, as described in documents WO 2005/042459, WO 2005/047224 and WO 2005/047226.

When the C₃ precursor compound is, for example, propane, the heterogeneously catalyzed partial gas phase oxidation for preparing acrylic acid can be carried out, for example, as described in documents EP-A 608 838, DE-A 198 35 247, DE-A 102 45 585 and DE-A 102 46 119.

When the C₃ precursor compound is, for example, glycerol, the heterogeneously catalyzed partial gas phase oxidation for preparing acrylic acid can be carried out, for example, as described in documents WO 2007/090991, WO 2006/114506, WO 2005/073160, WO 2006/114506, WO 2006/092272 or WO 2005/073160.

It has also already been proposed to obtain the propylene as the C₃ precursor compound by a partial dehydrogenation and/or oxydehydrogenation of propane preceding the partial gas phase oxidation (e.g. WO 076370, WO 01/96271, EP-A 117146, WO 03/011804 and WO 01/96270). This route can likewise be taken in the context of the inventive procedure.

High-boiling absorbents are understood in this document to mean absorbents whose boiling point at standard pressure is above that of acrylic acid. Advantageously in accordance with the invention, the boiling point of the absorbent at standard pressure (1 atm) is at least 20° C., preferably at least 50° C., more preferably at least 75° C. and most preferably at least 100° C. or at least 125° C. above the boiling point of acrylic acid (141° C. at 1 atm) at the same pressure. In general, the boiling point of the absorbent used for the process according to the invention at standard pressure is at values of ≦400° C., frequently ≦350° C. and in many cases also ≦300° C. or ≦280° C.

In a manner particularly suitable for the process according to the invention, the boiling point of the absorbent used for the process according to the invention, at standard pressure, is at values in the range from 200° C. to 350° C., preferably in the range from 200 to 300° C. For example, useful absorbents include all of those which satisfy the aforementioned boundary conditions and are recommended in the documents DE-A 103 36 386, DE-A 024 49 780, DE-A 196 27 850, DE-A 198 10 962, DE-A 043 08 087, EP-A 0 722 926 and DE-A 044 36 243.

In general, the high-boiling absorbents are organic liquids.

For the process according to the invention, particular preference is also given to absorbents which consist to an extent of at least 70% by weight of those organic molecules which do not comprise any externally active polar groups and are therefore, for example, incapable of forming hydrogen bonds.

Absorbents which are particularly favorable in accordance with the invention are, for example, diphenyl ether, diphenyl (=biphenyl), mixtures, known as Diphyl®, of diphenyl ether (70 to 75% by weight) and diphenyl (25 to 30% by weight), and also dimethyl phthalate, diethyl phthalate and mixtures of diphyl and dimethyl phthalate or diphyl and diethyl phthalate or diphyl, dimethyl phthalate and diethyl phthalate. A group of mixtures which is very particularly suitable as absorbents for use in accordance with the invention is that of those composed of 75 to 99.9% by weight of diphyl and 0.1 to 25% by weight of dimethyl phthalate and/or diethyl phthalate.

For example, in the comparative example and in the example of this document, the absorbent used may also be a corresponding mixture of 75 to 99.9% by weight of diphyl and 0.1 to 25% by weight of diethyl phthalate. Suitable diethyl phthalate for this purpose is, for example, >99% by weight diethyl phthalate from BASF SE.

The temperature T¹ in the process according to the invention is normally above that temperature that the bottoms liquid has in the bottom space of the absorption column. According to the position of the boiling points of the absorbents for use in accordance with the invention at standard pressure, the temperature T¹ in the process according to the invention is normally ≧100° C., preferably ≧130° C., more preferably ≧150° C. and most preferably ≧170° C. Normally, the temperature T¹ in the inventive procedure is, however, ≦300° C., frequently ≦250° C. By way of example, T¹ in the process according to the invention may be 170 to 220° C. or 180 to 210° C. or 190 to 200° C.

At the same time, the distillative separation in the distillation column, advantageously in accordance with the invention (appropriately in application terms) is performed under reduced pressure. Advantageously, the top pressure in the distillation column is 10 to 250 mbar, more preferably 20 to 200 mbar, even more preferably 30 to 150 mbar and even better 40 to 100 mbar.

The process according to the invention will preferably be performed at a minimum top pressure in the distillation column and, resulting from this, at a minimum T¹.

The temperature T² will be at least as great as the temperature T¹, or greater than the latter (T²≧T¹). Advantageously in accordance with the invention, T² is greater than T¹ (T²>T¹). In general, T² in the process according to the invention will, however, not be more than 50° C., frequently not more than 25° C. and in many cases not more than 15° C. above T¹. Usually, T² is, however, at least 1° C. above T¹.

The circulation heat exchanger of the distillation unit is understood in this document to mean an indirect heat exchanger present outside the distillation column. Indirect heat exchangers have at least one primary space and at least one secondary space. These primary and secondary spaces are separated from one another by a material dividing wall (the heat transfer wall), through which the heat is transferred. The residual stream R^{M} of stream M is passed through the at least one primary space, while at least one fluid heat carrier (e.g. steam, i.e. water vapor under pressure) flows through the at least one secondary space. Subsequently, the residual stream R^{M}, flowing out of the at least one primary space, is recycled into the distillation column above the withdrawal of the stream M from the distillation column.

The temperature T^{F} of the fluid heat carrier is necessarily >T¹.

Ultimately, the circulation heat exchanger in the process according to the invention functions as a circulation evaporator. In other words, that amount of thermal energy required to bring about the desired separation into vapor and concentrate in the distillation column is supplied to the residual stream R^{M} as it flows through the circulation heat exchanger. Normally, the temperature T² is such that the residual stream R^{M} is in the boiling state on reentry into the distillation column.

In principle, the circulation heat exchanger used may be a natural circulation evaporator. Advantageously in accordance with the invention, however, a forced circulation evaporator (forced circulation heat exchanger) is used for the process according to the invention, in which the residual stream R^{M} is not, as in the natural circulation evaporator, conveyed through by natural circulation (following the gradient of the mass density), but instead is conveyed through the circulation heat exchanger by means of a pump (cf., for example, FIG. 2 of WO 2005/007609).

Indirect heat exchangers suitable as circulation heat exchangers for the process according to the invention are, for example, double tube, tube bundle, finned tube, spiral or plate heat exchangers (heat transferors). Particularly suitable for the process according to the invention are tube bundle heat transferors as circulation heat exchangers. They normally consist of a closed wide outer tube which surrounds the numerous smooth or finned transferor tubes (exchanger tubes) of small diameter which are secured to tube plates. Appropriately in accordance with the invention, the residual stream R^{m} flows within the transferor tubes (in principle, it may, however, also flow within the space surrounding the transferor tubes, and the fluid heat carrier within the transferor tubes).

In other words, the fluid heat carrier (preferably saturated steam), advantageously in accordance with the invention, flows outside the transferor tubes. The flow in the outer space (secondary space) advantageously runs transverse to the transferor tubes. According to the flow direction of the outer space fluid in relation to the transferor tubes, it is possible to distinguish, for example, longitudinal flow and crossflow, and also transverse flow tube bundle heat transferors. In principle, the fluid heat transferor can also be moved around the transferor tubes in a meandering manner and only when viewed over the tube bundle heat exchanger conducted in cocurrent or countercurrent to the residual stream R^{M} to be heated in accordance with the invention.

In the single-flow tube bundle heat transferor, the residual stream R^{M} to be heated in accordance with the invention moves (flows) through all transferor tubes in the same direction. Multiflow tube bundle heat transferors comprise tube bundles divided into individual sections (in general, the individual sections comprise an identical number of tubes).

Dividing walls divide chambers which adjoin the tube plates (through which the transferor tubes are secured with sealing and to which they are secured) into sections and deflect the residual stream R^{M} which enters the chamber part from one section into a second section and hence back. The residual stream R^{M} to be heated in accordance with the invention, according to the number of sections, flows through the length of the tube bundle heat transferor more than once (twice, three times, four times, etc.) at high velocity in alternating directions (two-flow, three-flow, four-flow, etc. tube bundle heat transferor). Heat transfer coefficient and exchange path increase correspondingly.

Alternatively to water vapor, useful fluid heat transferors include oils, melts, organic liquids and hot gases. Examples thereof are silicone compounds such as tetraaryl silicate, diphenyl-comprising mixture of 74% by weight of diphenyl ether and 26% by weight of diphenyl, the azeotrope of diphenyl and diphenyl ether, chlorinated noncombustible diphenyl, and mineral oils and pressurized water. When water vapor is used as the heat transferor, it is generally favorable when the water vapor condenses as it flows through the circulation heat exchanger (saturated steam). In principle, all possible hot gases, vapors and liquids are useful as fluid heat carriers.

Preferred circulation heat exchangers for the process according to the invention are forced circulation tube bundle heat transferors. Advantageously, the residual stream R^{M} is forcibly conveyed into the tubes thereof.

Most preferably in accordance with the invention, the circulation heat exchanger of the distillation unit is configured as a forced circulation flash heat transferor (a forced circulation flash heat exchanger), preferably a forced circulation tube bundle flash heat transferor (forced circulation tube bundle flash heat exchanger).

In contrast to the case of a pure forced circulation heat exchanger (forced circulation heat transferor), the former is normally separated from the recycle point of the residual stream R^{M} into the distillation column by a throttle device (for example in the simplest case a perforated plate (or other restrictor); alternatively, a valve is also an option).

The above measure suppresses boiling of the residual stream R^{M} pumped in circulation within the at least one primary space of the heat transferor (heat exchanger; for example in the tubes of the tube bundle heat transferor). The residual stream R^{M} pumped in circulation is instead superheated within the at least one primary space with respect to the gas phase pressure GD existing at the recycle point in the distillation column, and the boiling process is thus moved completely to the passage side of the throttle device (i.e. the contents of the tubes of the tube bundle heat transferor are present in monophasic form; the tube bundle heat transferor functions merely as a superheater). The throttle device separates the circulation heat exchanger (e.g. tube bundle heat exchanger) and the recycle point into the distillation column on the pressure side and enables, through suitable selection of the output of the delivery pump, the establishment of a throttle admission pressure above the gas phase pressure GD, and above the boiling pressure, corresponding to the temperature T², of the stream R^{M} flowing out of the at least one primary space of the heat transferor. The evaporative boiling does not take place until beyond the throttle in flow direction. The use of forced circulation flash heat exchangers is preferred in the process according to the invention, as already stated. The difference between the throttle admission pressure and the gas phase pressure GD is typically 0.1 to 5 bar, frequently 0.2 to 4 bar and in many cases 1 to 3 bar. The temperature of the stream flowing out of the at least one primary space of the forced circulation flash heat exchanger is, as it leaves the at least one primary space (still upstream of the throttle in flow direction), generally at least 5° C. above T¹.

Owing to the withdrawal of the stream M at the lower end of the distillation column and to the concentrate which descends continuously to this lower end, a level S of the concentrate is established in the distillation column at the lower end thereof in the course of the process according to the invention (the level S is the distance from the lowest point in the distillation column to the liquid level of the concentrate).

Especially in the case of use of a forced circulation flash heat exchanger as the circulation heat exchanger, the residual stream R^{m} recycled into the distillation column with the temperature T² via the circulation heat exchanger is recycled into the distillation column above the level S (but normally below half the height of the distillation column). Under these conditions, the temperature T¹ is regularly below the boiling temperature corresponding to the gas phase pressure GD existing above the level S.

The selection of the site for the feed of the bottoms liquid which originates from the bottom space of the absorption column into the distillation unit is not particularly critical in the process according to the invention. When the circulation heat exchanger used in the distillation unit is a forced circulation flash heat exchanger, it is appropriate in application terms to undertake this feed into the residual stream R^{M} recycled into the distillation column via the circulation heat exchanger, and to provide (arrange) the feed point, viewed in flow direction of the residual stream R^{M}, beyond the throttle device but upstream of the recycle point into the distillation column. It is convenient to do this not least because the residual stream R^{M} recycled into the distillation column via the circulation heat exchanger is normally significantly greater than the stream of bottoms liquid which originates from the bottom space of the absorption column and is fed to the distillation unit (the basis of the size comparison is the particular mass flow).

In general, it is even advantageous in this case (or quite generally) to undertake the feed of the bottoms liquid into the distillation unit in a cyclical manner. In this case, the level S of the concentrate in the distillation column is not a constant considered over the operating time of the process according to the invention, but varies with the operating time between a maximum level (a maximum S^{max} for S) and a minimum level (a minimum S^{min} for S).

As soon as S^{max} is attained, the feed of the bottoms liquid into the distillation unit is stopped. Thereafter, S^{max} falls to S^{min} with further operating time. Once this point has been attained, the feed of bottoms liquid into the distillation unit is restarted. The level S is advantageously regulated contactlessly with the aid of a “radioactive level control system”, as described, for example, in Process Engineering, edition 3, pages 62-63 (1975) and Polytechnisch Tijdschrift Processtechniek, volume 27(8), pages 251-257 (1972).

The mean residence time t^{V} of the constituents of the substream T^{Au} in the distillation unit is defined as follows for the purposes of the inventive procedure.

The total volume V^{G}=V^{K}+V^{Z}+V^{P}+V^{R} is calculated from the volume V^{k} of the liquid concentrate present in the distillation column from the lowest point in the distillation column to the level S, the volume V^{Z} of the feed line (including the pump) through which the residual stream R^{M} is delivered from the distillation column to the circulation heat exchanger, the volume V^{P} of the at least one primary space of the circulation heat exchanger through which the residual stream R^{M} is conducted, and the volume V^{R} of the recycle line through which the residual stream R^{M} is recycled from the circulation heat exchanger into the distillation column, as the sum of the aforementioned individual volumes.

t^{V} is then calculated as V^{G} divided by the flow \dot{T}^{Au} (as volume/time) of the substream T^{Au}.

When the level S is not constant as a function of the operating time, but variable because, for example, the bottoms liquid is fed into the distillation unit in a cyclical manner, V^{K} is the mean over time determined via the cycle time.

In the case of use of a forced circulation evaporator as the circulation heat exchanger, S^{min} is generally selected such that the risk that the delivery pump accidentally draws gas phase is essentially eliminated.

The recycling of the residual stream R^{M} conducted through the circulation heat exchanger into the distillation column (or of the mixed stream composed of heated residual stream R^{M} to be recycled and stream of bottoms liquid to be supplied) is, incidentally, advantageously in application terms, undertaken tangentially (i.e. this stream is fed into the distillation column in such a way that it flows within the distillation column tangentially along the cylindrical outer wall of the distillation column).

The reduction of t^{V} is possible in a simple manner, for example, by, for a given distillation unit, firstly increasing the flow rate of bottoms liquid which originates from the bottom space of the absorption column and is conducted into the distillation unit, and secondly increasing the magnitude of the substream T^{Au}. At the same time, both the flow rate of the fluid heat carrier conducted through the at least one secondary space of the circulation heat exchanger (e.g. water vapor (saturated steam)) and the flow rate of the residual stream R^{M} conducted through the at least one primary space of the circulation heat exchanger will be increased.

In this way, T² and S^{min/max} remain essentially constant in the course of the reduction of t^{V}. When the distillation unit, in contrast, is still adjustable (i.e. not already defined), the adjustment of V^{G}, for example, also gives a sufficient degree of configuration leeway to influence t^{V}.

For example, V^{K} can be reduced at the same S^{min} by introducing displacement bodies in the distillation column at the lower end thereof or narrowing the cross section of the distillation column.

Preferably in accordance with the invention, t^{V} (as already stated) is ≧5 h and ≦30 h, more preferably ≧10 and ≦25 h.

Otherwise, the distillation column is essentially free of internals, and preferably no internals are present in the distillation column.

When the circulation heat exchanger is a forced circulation heat exchanger, the delivery pump used is preferably a radial centrifugal pump with a closed or a semiopen radial impeller (cf. DE-A 10228859 and DE 102008054587). When the circulation heat exchanger is a forced circulation flash evaporator, it can advantageously also be operated as described in PCT/EP2009/055014.

In principle, the discharge of the substream T^{Au} can likewise be undertaken in a cyclical manner. To calculate t^{V}, the flow rate \dot{T}^{Au} averaged over the cycle time is then used. Typical closure times may, for example, be 5 min to 2 h, frequently 30 min to 2 h, and often 1 h to 2 h. Typical opening times are 5 to 10 seconds. The above is especially also true under the conditions of the comparative example and of the example of this document. The discharge pipeline used is, appropriately in application terms, a DN80 PN10 pipeline, and the shutoff fitting is advantageously a DN50 PN10 ballcock. Otherwise, the description in EP-A 1 452 518 can be followed. Normally, the substream T^{Au} discharged is sent to incineration (cf. WO 97/48669, EP-A 925272 and DE-A 10 2005053982).

Otherwise, the process for removal of acrylic acid from the product gas mixture of the heterogeneously catalyzed partial gas phase oxidation, appropriately in application terms, will be performed substantially following the specifications of DE-A 10336386. It is also possible to proceed as described in the flow diagrams of DE-A 19606877 and DE-A 1960687. Alternatively, it is possible to proceed as in DE-A 10251138.

The vapor obtained in the distillation column from the bottoms liquid originating from the bottom space of the absorption column can in principle be recycled as such into the absorption column. Preferably in accordance with the invention, the vapor stream will, however, first be cooled and condensed indirectly, in heat exchangers which are known per se to those skilled in the art and are not subject to any particular restriction, or directly, for example by means of a quench. The indirect heat exchangers used for this purpose may, for example, be air coolers (e.g. finned tubes in which the vapor stream is conducted from the top downward and which are supplied from outside with ambient air with the aid of ventilators) or river water condensers. It is, however, also possible to use a combination of direct and indirect cooling. The vapor condensate formed is subsequently advantageously sent to a buffer vessel in which it is generally stored intermediately at a temperature of 30 to 50° C.

With the aid of a pump, the vapor condensate, appropriately in application terms, is recycled continuously from the buffer vessel into the absorption column. Recycling in condensed form is advantageous in that the condensate can directly display absorptive action in the absorption column. The vapor condensate is preferably recycled into the middle region of the absorption column. If required, it can also be recycled into the absorption column in a mixture with liquid phase, which has been conducted out beforehand from a collecting tray within the absorption column.

When low boilers are stripped out of the remaining residual amount R^{A} of adsorbate A conducted out of the absorption column in a stripping unit to obtain an adsorbate A* depleted of low boilers, which is subsequently sent to a rectification column with rectifying section and stripping section, in order to enrich the acrylic acid in the rectifying section of this rectification column and to conduct it out of the rectifying section as crude acrylic acid with a proportion by weight of acrylic acid of ≧90% by weight, a reduction in the glyoxal content of the crude acrylic acid can additionally or also be brought about by performing the stripping particularly intensively. The term “stripping” here shall comprise especially the stripping of low boilers out of the adsorbate A by means of the stripping gases passed through the adsorbate A, for example molecular oxygen, air, carbon dioxide and/or cycle gas (cf., for example, DE-A 10336386 and EP-A 925272). However, it shall also include desorption (the removal of an absorbed low boiler from the adsorbate) by, for example, heating or by reducing the pressure in the gas phase. It will be appreciated that it also comprises all possible combinations of the individually encompassed process measures. The intensity of the stripping is promoted by increasing the stripping temperature, reducing the stripping pressure and by increasing the flow of the stripping gas stream used based on a stream of adsorbate A.

Preferably, the stripping of a remaining residual amount R^{A} will be performed in a stripping column in which the stripping gas and the residual amount R^{A} are conducted in countercurrent to one another. For example, the stripping can be performed in analogy to the remarks in DE-A 4308087 and in DE-C 2136396. In principle, however, it is also possible to strip as in EP-A 1041062. When the stripping is performed in the form of stripping out with a stripping gas, a suitable stripping column is especially a tray column. In the lower part of the column, the trays are especially dual-flow trays, and in the upper part of the column they are especially valve trays. The residual amount R^{A} is introduced in the top region of the stripping column, and the stripping gas is, appropriately in application terms, conducted into the stripping column below the lowermost dual-flow tray and above the liquid level.

Over and above the statements made so far, the process according to the invention should be performed such that the bottoms liquid present in the bottom space of the absorption column has a minimum proportion by weight of heavy metals/heavy metal ions (especially transition metal ions) or of any metals/metal ions at all, since they can enhance the undesired polymerization tendency of acrylic acid. Preferably in accordance with the invention, this proportion by weight is less than 1 ppm by weight (based on the weight of the bottoms liquid) per metal or per heavy metal (per transition metal). These metals include especially the metals Cr, Co, Cd, Fe, Mn, Mo, Ni, Sn, V, Zn, Zr, Ti, Sb, Bi and Pb, but also Al, Ca, Mg, K and Li. The aforementioned proportion by weight of heavy metals or metals is more preferably vanishingly small.

Possible sources for a metal contamination as described above include especially the catalyst bed used for the heterogeneously catalyzed partial gas phase oxidation and the manufacturing materials used for the equipment involved. This is in particular because the catalysts used as active materials for the partial oxidation are normally multimetal oxide materials comprising Mo, Bi and Fe and/or multimetal oxide materials comprising Mo and V. Owing to its water vapor content, the reaction mixture is capable, for example, of promoting the discharge of molybdenum oxides from the active materials. Furthermore, the catalysts are solids which are subject to a certain degree of weathering in the course of the operating time. As a consequence, there may be a discharge of fine catalyst dust with the reaction gas mixture. Appropriately in accordance with the invention, the process for heterogeneously catalyzed partial gas phase oxidation will therefore be performed as detailed in WO 2005/042459 or in WO 2005/113127 using the example of a two-stage heterogeneously catalyzed partial gas phase oxidation of propene to acrylic acid.

The materials used for the equipment involved are especially those recommended in DE-A 10336386. The material used is preferably 1.4571 (to DIN EN 10020), advantageously with a very smooth surface. It will be appreciated that it is also possible to use the materials recommended in WO 2005/007609. Optionally, substances which complex metals, for example EDTA, can be added to the bottoms liquid in the bottom space of the absorption column.

The absorbent conducted out of the stripping section of the rectification column with a proportion by weight of acrylic acid of ≦1% by weight is, appropriately in application terms, recycled into the process for removal of acrylic acid from the product gas mixture of the gas phase partial oxidation.

The acrylic acid-depleted gas stream which flows out of the absorption column is generally also subjected to a condensation of the water vapor normally present therein. The resulting condensate is referred to as acid water. The residual gas remaining in the acid water condensation is generally partly recycled into the gas phase partial oxidation as diluent gas, partly incinerated and partly used as stripped gas for the stripping of low boilers out of the residual amount R^{A}. Prior to the aforementioned further use as stripping gas, it is preferably scrubbed with absorbent conducted out of the stripping section of the rectification column, before the latter is recycled into the absorption column. Prior to this recycling, it is appropriate to extract a portion with acid water. The acid water extract obtained is advantageously stripped with residual gas to be supplied to the incineration thereof, before the two are incinerated. The stripping gas which flows out of the low boiler stripping column and is laden with low boilers is appropriately conducted into the direct cooler.

In the example and comparative example which follow, the product gas mixture of the gas phase partial oxidation was analyzed for its composition as follows. A small branch stream was passed through an indirectly cooled cold trap and all constituents which condense out were collected in the condensate which forms. The condensate was subsequently analyzed for its composition using chromatographic methods. The glyoxal determination was performed as described in this document. The constituents which remain in gaseous form in the condensation were determined by gas chromatography or spectroscopy (carbon dioxide, for example, by means of infrared spectroscopy). The content of molecular oxygen was determined on the basis of the magnetic properties thereof. The remaining determinations were also carried out in an analogous manner. The glyoxal contents are (to the extent that they have been determined) reported on the basis of the molar amounts of glyoxal determined, and as proportions by weight of a molar amount of monomeric glyoxal equivalent to the particular molar amount of glyoxal.

The present invention thus comprises especially the following embodiments:
1. A process for removal of acrylic acid from the product gas mixture of a heterogeneously catalyzed partial gas phase oxidation of at least one C₃ precursor compound to acrylic acid, said product gas mixture comprising, in addition to acrylic acid, steam and glyoxal, also low boilers, medium boilers, high boilers and uncondensables other than the aforementioned compounds as secondary constituents,
   in which
      the product gas mixture is cooled in a direct cooler by direct cooling with a finely sprayed cooling liquid, which evaporates a portion of the cooling liquid,
      the cooled product gas mixture together with evaporated and unevaporated cooling liquid is conducted into the bottom space of an absorption column, said bottom space being connected to the absorption space which is above it in the absorption column and has separating internals by a chimney tray K which is present between the two and has at least one chimney, from which
      the cooled product gas mixture and evaporated cooling liquid flow through the at least one chimney of the chimney tray K into the absorption space and ascend therein in countercurrent to a high-boiling absorbent which descends therein, in the course of which adsorbate A comprising acrylic acid absorbed in the absorbent accumulates on the chimney tray K,
      adsorbate A which comprises acrylic acid absorbed in the absorbent and accumulates on the chimney tray K is conducted therefrom out of the absorption column,
      a portion of adsorbate A conducted out of the absorption column is fed to the bottom space of the absorption column to form a bottoms liquid present in the bottom space, and, optionally, another portion of the adsorbate A is cooled and recycled into the absorption column above the chimney tray K,
      optionally, low boilers are stripped out of the remaining residual amount R^{A} of adsorbate A conducted out of the absorption column in a stripping unit to obtain an adsorbate A* depleted in low boilers,
      the residual amount R^{A} of adsorbate A or the adsorbate A* is fed to a rectification column with a rectifying section and stripping section,
      in the stripping section of the rectification column, the absorbent is enriched, and absorbent is conducted out of the stripping section with a proportion by weight of acrylic acid of ≦1% by weight, and
      in the rectifying section of the rectification column, the acrylic acid is enriched, and a crude acrylic acid with a proportion by weight of acrylic acid of ≧90% by weight is conducted out of the rectifying section,
      bottoms liquid comprising absorbent is withdrawn from the bottom space of the absorption column, a portion of this withdrawn bottoms liquid is fed to the direct cooler as cooling liquid and the residual amount of this withdrawn bottoms liquid is fed to a distillation unit which comprises a distillation column and a circulation heat exchanger,
      in the distillation column, the bottoms liquid fed to the distillation unit is separated by distillation into vapor in which the proportion by weight of absorbent is greater than the proportion by weight of absorbent in the bottoms liquid, and into liquid concentrate in which the proportion by weight of constituents B with higher boiling points than the absorbent is greater than the proportion by weight of constituents B in the bottoms liquid,
      a stream of the vapors, optionally after cooling and/or condensation thereof in an indirect heat exchanger, is recycled into the absorption column above the chimney tray K,
      at the lower end of the distillation column, a stream M of the concentrate which accumulates there in liquid form at a level S is conducted out of the distillation column with the temperature T¹,
      a substream T^{Au} of this stream M is discharged from the process for removal of acrylic acid from the product gas mixture, and
      the residual stream R^{M} of the stream M is recycled into the distillation column via the circulation heat exchanger with the temperature T²≧T¹ above the withdrawal of the stream M from the distillation column,
      wherein the mean residence time t^{V} of the constituents of the substream T^{Au} in the distillation unit is ≦40 h.
2. The process according to embodiment 1, wherein the circulation heat exchanger of the distillation unit is a forced circulation flash evaporator.
3. The process according to embodiment 1 or 2, wherein the product gas mixture of the partial gas phase oxidation, based on the molar amount of acrylic acid present therein, comprises ≧1 molar ppm of glyoxal.
4. The process according to embodiment 1 or 2, wherein the product gas mixture of the partial gas phase oxidation, based on the molar amount of acrylic acid present therein, comprises ≧10 molar ppm of glyoxal.
5. The process according to embodiment 1 or 2, wherein the product gas mixture of the partial gas phase oxidation, based on the molar amount of acrylic acid present therein, comprises ≧100 molar ppm of glyoxal.
6. The process according to any of embodiments 1 to 5, wherein the C₃ precursor compound is propylene, propane, glycerol and/or acrolein.
7. The process according to any of embodiments 1 to 6, wherein the boiling point of the absorbent at standard pressure is at least 20° C. above the boiling point of acrylic acid at the same pressure.
8. The process according to any of embodiments 1 to 6, wherein the boiling point of the absorbent at standard pressure is at least 50° C. above the boiling point of acrylic acid at the same pressure and at ≦300° C.
9. The process according to any of embodiments 1 to 8, wherein the absorbent is a mixture of 75 to 99.9% by weight of diphyl and 0.1 to 25% by weight of dimethyl phthalate.
10. The process according to any of embodiments 1 to 9, wherein T¹≧100° C.
11. The process according to any of embodiments 1 to 9, wherein T¹≧150° C.
12. The process according to any of embodiments 1 to 9, wherein T¹≧170° C. and ≦220° C.
13. The process according to any of embodiments 1 to 11, wherein T¹≦300° C.
14. The process according to any of embodiments 1 to 13, wherein T² is up to 50° C. above T¹.
15. The process according to any of embodiments 1 to 13, wherein T² is ≧1° C. and ≦15° C. above T¹.
16. The process according to any of embodiments 1 to 15, wherein the circulation heat exchanger is a forced circulation flash evaporator and the residual stream R^{M} recycled into the distillation column with the temperature T² via the circulation heat exchanger is recycled into the distillation column above the level S of the concentrate.
17. The process according to any of embodiments 1 to 16, wherein t^{V} is ≧5 h and ≦30 h.
18. The process according to any of embodiments 1 to 16, wherein t^{V} is ≧10 h and ≦25 h.
19. The process according to any of embodiments 1 to 18, wherein low boilers are stripped out of the remaining residual amount R^{A} of adsorbate A conducted out of the absorption column in a stripping column.
20. The process according to any of embodiments 1 to 19, wherein the content of metal ions in the bottoms liquid in the bottom space of the absorption column is ≦1 ppm by weight per metal type.
21. The process according to any of embodiments 1 to 20, wherein the content of Cr, Co, Cd, Fe, Mn, Mo, Ni, Sn, V, Zn, Zr, Ti, Sb, Bi, P, Al, Ca, Mg, K and Li in the bottoms liquid in the bottom space of the absorption column is ≦1 ppm by weight per metal mentioned.
22. The process according to any of embodiments 1 to 21, wherein the crude acrylic acid is conducted out of the rectifying section of the rectification column with a proportion by weight of acrylic acid of ≧95% by weight.
23. The process according to any of embodiments 1 to 22, wherein the top pressure in the distillation column of the distillation unit is 10 to 250 mbar.
24. The process according to any of embodiments 1 to 23, wherein the absorbent conducted out of the stripping section of the rectification column with an acrylic acid content of ≦1%, by weight is recycled into the process for removal of acrylic acid from the product gas mixture of the gas phase partial oxidation.

### EXAMPLE AND COMPARATIVE EXAMPLE

### Comparative Example

From a heterogeneously catalyzed gas phase partial oxidation, performed in two stages, of propylene of chemical-grade purity to acrylic acid with a cycle gas method (as described in WO 2008/090190), a product gas mixture with a temperature of 296.7° C. and a pressure of 1.69 bar was obtained with the following contents:

| | | |
|---|---|---|
| 11.632% | by wt. of | acrylic acid, |
| 0.277% | by wt. of | acetic acid, |
| 4.796% | by wt. of | H₂O, |
| 0.0045% | by wt. of | diphyl, |
| 0.0001% | by wt. of | dimethyl phthalate, |
| 0.138% | by wt. of | formic acid, |
| 0.0741% | by wt. of | acrolein, |
| 0.0029% | by wt. of | propionic acid, |
| 0.0034% | by wt. of | furfurals, |
| 0.0004% | by wt. of | allyl acrylate, |
| 0.0029% | by wt. of | benzaldehyde, |
| 0.0839% | by wt. of | maleic anhydride, |
| 0.0025% | by wt. of | benzoic acid, |
| 3.499% | by wt. of | molecular oxygen, |
| 2.097% | by wt. of | carbon dioxide, |
| 0.658% | by wt. of | carbon monoxide, |
| 0.479% | by wt. of | propane, |
| 0.239% | by wt. of | propylene, |
| 0.0251% | by wt. of | glyoxal, and |
| 75.959% | by wt. of | molecular nitrogen. |

The product gas mixture (272 403 kg/h) was cooled to a temperature of 156.8° C. in a spray cooler (direct cooler; quench 1) operated in cocurrent (cf. DE-A 10063161 and EP-A 1345881).

The liquid used for direct cooling of the product gas mixture was a portion of the bottoms liquid withdrawn by means of the delivery pump P9 (the delivery pumps in this comparative example were appropriately radial centrifugal pumps according to DE-A 102 28 859) from the bottom space of the absorption column described hereinafter (the bottoms level was regulated contactlessly with the aid of a “radioactive level control system”). The cooling action resulted primarily from a partial evaporation of the absorbent. Still upstream of the corresponding delivery pump P9, the bottoms liquid withdrawn from the bottom space of the absorption column was supplemented with a mixture G of fresh absorbent and absorbent which was conducted out, below the lowermost tray, of the stripping section of the rectification column K30 described hereinafter and comprised ≦1% by weight of acrylic acid. This supplementation stream firstly made a small contribution to keeping the circulation rate of the direct cooling in a steady state. However, it functioned primarily as a purge stream for the replacement pump (reserve pump) of delivery pump P9, with the aid of which it was kept free of sediment and ready for immediate operation.

For this purpose, the two delivery pumps (P9=in operation; P9*=reserve) were each in a branch of a T-piece of the delivery line, which was combined again downstream of the two pumps in delivery direction. Both on the suction side and on the pressure side of each of the two pumps was, in the particular branch of the delivery line, a fitting, with the aid of which the stream could be shut off (in its simplest embodiment, the particular fitting is a vane or a flap).

While the two fittings belonging to the delivery pump P9 in operation were open, those of the reserve pump P9* kept ready for operation were closed. The purge stream was then, appropriately in application terms, in flow direction (of the stream which is normally to be conveyed by the delivery pump P9* in operation), downstream of the delivery pump P9* but upstream of the shutoff fitting (upstream of the closed pressure side vane of the delivery pump P9*), switched to the delivery pump P9*, such that the purge stream flowed back through the delivery pump P9* at rest (counter to the normal delivery direction thereof). The fitting on the suction side of the delivery pump P9* was preferably likewise shut off (the suction side flap was preferably likewise closed). However, from the suction side of the delivery pump P9*, a bypass line with nominal width 50 was conducted around the latter to the suction side of the delivery pump P9 in operation, through which the purge stream leaving through the suction orifice of the delivery pump P9* could flow to the suction side of the delivery pump P9 in operation.

The supplementation stream of mixture G withdrawn from the buffer vessel B 8000 (727 kg/h; 39.8° C.) had the following contents:

| | | |
|---|---|---|
| 0.974% | by wt. of | acrylic acid, |
| 0.0001% | by wt. of | acetic acid, |
| 74.64% | by wt. of | diphyl, |
| 18.81% | by wt. of | dimethyl phthalate, |
| 0.0002% | by wt. of | propionic acid, |
| 0.01% | by wt. of | furfurals, |
| 0.199% | by wt. of | benzaldehyde, |
| 0.746% | by wt. of | maleic anhydride, |
| 0.323% | by wt. of | benzoic acid, |
| 4.191% | by wt. of | diacrylic acid, and |
| 0.0544% | by wt. of | phenothiazine. |

The liquid used overall for direct cooling (1 120 430 kg/h; 152.4° C.) had the following contents:

| | | |
|---|---|---|
| 4.49% | by wt. of | acrylic acid, |
| 0.0253% | by wt. of | acetic acid, |
| 0.0099% | by wt. of | water, |
| 55.77% | by wt. of | diphyl, |
| 37.85% | by wt. of | dimethyl phthalate |
| 0.0003% | by wt. of | formic acid, |
| 0.0025% | by wt. of | acrolein, |
| 0.0007% | by wt. of | propionic acid, |
| 0.0023% | by wt. of | furfurals, |
| 0.0001% | by wt. of | allyl acrylate, |
| 0.0291% | by wt. of | benzaldehyde, |
| 0.1374% | by wt. of | maleic anhydride, |
| 0.366% | by wt. of | benzoic acid, |
| 0.966% | by wt. of | diacrylic acid, |
| 0.280% | by wt. of | phenothiazine, and |
| 0.0001% | by wt. of | molecular oxygen. |

The direct cooling was effected as described in EP-A 1345881. The direct cooler K9 had a cylindrical geometry. Its height was 15 704 mm, its internal diameter was 3 m. The construction material was 1.4571 material (DIN EN 10020) with a thickness of 5 to 8 mm. At the lower end thereof, it was concluded by a cone which had a draw stub with an internal diameter of 2000 mm. At the upper end thereof, it was concluded by a cone which had an inlet stub with an internal diameter of 2000 mm. A cylindrical collar (internal diameter=2710 mm, collar height=1124 mm) projected from the conical inner wall, mounted centrally, into the direct cooler. The cylindrical collar had a jacketed design (in a manner corresponding to a Dewar vessel; the cavity enclosed by the two walls was filled with mineral wool; the distance between the two walls was 100 mm; the cavity was sealed from the streams).

2530 mm below the inlet stub through which the product gas mixture flowed into the direct cooler, six baffle plate atomizers were mounted in equidistant distribution around the circumference of the direct cooler, as disclosed in EP-A 1345881 (cf. working example of this EP document). The cooling liquid was nebulized by means of the latter to droplets of diameter 0.1 mm to 5 mm and fed to the direct cooler.

1900 mm above the draw stub was also mounted a lateral inlet stub. Through the latter was supplied the stripping gas laden with low boilers, which resulted from the low boiler stripping, which is still to be described below, of the residual amount R^{A} of the adsorbate A conducted out of the absorption column (or R^{A+}, A⁺). The stripping gas laden with low boilers (78 318 kg/h; 118.7° C., 1.520 bar) had the following contents:

| | | |
|---|---|---|
| 39.216% | by wt. of | acrylic acid, |
| 0.361% | by wt. of | acetic acid, |
| 1.130% | by wt. of | water, |
| 1.823% | by wt. of | diphyl, |
| 0.0489% | by wt. of | dimethyl phthalate |
| 0.0032% | by wt. of | formic acid, |
| 0.0187% | by wt. of | acrolein, |
| 0.0082% | by wt. of | propionic acid, |
| 0.0069% | by wt. of | furfurals, |
| 0.0018% | by wt. of | allyl acrylate, |
| 0.0639% | by wt. of | benzaldehyde, |
| 0.234% | by wt. of | maleic anhydride, |
| 0.0023% | by wt. of | benzoic acid, |
| 0.0021% | by wt. of | diacrylic acid, |
| 4.469% | by wt. of | molecular oxygen, |
| 1.169% | by wt. of | carbon dioxide, |
| 0.367% | by wt. of | carbon monoxide, |
| 0.267% | by wt. of | propane, |
| 0.134% | by wt. of | propylene, and |
| 50.62% | by wt. of | molecular oxygen. |

Otherwise, the direct cooler K9 did not have any internals and was insulated thermally from the environment with 200 mm of mineral wool.

From the draw stub of the direct cooler, the overall mixture (T=156.8° C., P=1.469 bar) flowed directly into the bottom space of the absorption column K10. The weight ratio of liquid to gaseous phase in the overall mixture was approx. 2.5. The inlet stub for the overall mixture into the bottom space was mounted tangentially.

The height of the absorption column K10 was 53 263 mm. Both at the top and at the bottom, it was concluded by a torispherical end. From the bottom upward, the internal diameter of the absorption column was 8200 mm up to a height of 31 863 mm. Thereafter, the internal diameter, apart from the transition zone, was reduced to 7000 mm up to the upper end of the absorption column.

The lower torispherical end (also referred to as dished end) had a draw stub whose internal diameter was 600 mm. Immediately above the draw stub, a vortex (swirl) breaker was mounted in the absorption column. 2613 mm above the lower end of the absorption column was the base of a flat cone (“Chinese hat”) mounted centrally in the bottom space of the absorption column and open at the bottom. The tip of the flat cone was 3213 mm above the lower end of the column. At the height of its base, there was an edge gap of width 500 mm between the peripheral line of the flat cone and the inner wall of the absorption column. The purpose of the flat cone was to prevent gas phase flowing out below the base thereof from entraining liquid phase in droplet form from the bottom upward.

The middle of the inlet of the inlet stub for the overall mixture flowing in from the direct cooler K9 was at a height of 4113 mm on the side of the absorption column. The internal diameter of the inlet stub was 2000 mm. The inlet stub was mounted such that the overall mixture flowed tangentially into the bottom space of the absorption column K10.

The chimney tray K connected the bottom space of the absorption column to the absorption space above it. The chimney tray K was of the design described in DE-A 10159825. It had 16 cylindrical chimneys. The internal diameter thereof was 797 mm and the height thereof (without roof) was 2 m. Between roof and chimney end was a passage gap of 200 mm. The walls of the chimneys were in jacketed form (in a manner corresponding to that in a Dewar vessel; the cavity enclosed by the two walls was filled with air; the distance between the two walls was 20 mm; the cavity was sealed from the streams). This principle is employed in order to reduce thermal stress on the acrylic acid accumulating on the chimney tray.

On the underside of the chimney tray K was mounted centrally an open frustocone which projected downward, the cross section of which narrowed in the downward direction. The height of the frustocone was 1560 mm. From the top downward, the internal diameter of the frustocone narrowed from 6230 mm to 4200 mm. The lower end of the frustocone was additionally continued downward as a circular cylindrical collar, with a collar height of 600 mm. The distance from the middle of the inlet of the inlet stub to the lower end of the aforementioned collar was 3400 mm. The frustocone was surrounded by a ring at the lower end thereof. This ring had an internal diameter of 6200 mm and a width of 2319 mm.

About 1 m above the chimney ends (calculated without roof) of the chimney tray K was the underside of the first of five successive valve trays of similar design (as always in this column, valve plate trays from Koch International with the TU valve type and type H cage). The equidistant separation thereof was 700 mm. Valve trays 1 and 3 (from the bottom upward) had 5130 “valves/tray holes” per tray. Tray 2 had 4958 “valves/holes”. In these three trays, the valves and cages were not mounted. Tray 4 had 4958, and tray 5 had 5130, “valves/tray holes”. The diameter of the tray holes (as in the other valve trays in this column too) was 39 mm in all five trays. The centers of the tray holes were each distributed over a valve tray section according to regular triangular pitch. The individual valve trays were configured as four-flow crossflow trays. The height of the overflow weirs on trays 1 and 3 was 22 mm, that on trays 2 and 4 was 15 mm and that on tray 5 was 20 mm.

In a valve plate tray (in this document “valve tray” for short), the tray orifices (the gas passage orifices in the tray) are covered by lids or plates which are movable in the upward direction. When gas passes through, the lids (plates) are lifted by the gas stream within a corresponding guide structure mounted above the particular tray orifice (guide cage; in this column, type H from Koch International) and ultimately reach a lift height corresponding to the gas loading. The gas stream passes out of the passage orifice formed under the lifted plate and, parallel to the tray, enters the liquid accumulated thereon. The plate stroke thus controls the size of the gas passage orifice and adjusts automatically to the column loading.

The guide cage limits the maximum possible lift height (for example by the height of its lid; the latter is generally impervious to fluid phases). In general, this maximum lift height is about one quarter of the hole diameter.

Owing to the high gas loading of the lower valve trays, the lift covers (lift plates) are, appropriately in application terms, frequently omitted thereon. The gas stream is then deflected by the cover of the guide cage. This procedure is advantageous in that it rules out the possibility of a lift cover sticking fast on the tray orifice when it is temporarily not loaded. Optionally, the guide cages are additionally dispensed with. The thickness of a lift cover is, in applications of the type described, generally 1.5 (preferably in the case of valves further toward the inside) to 2 mm (preferably in the case of valves further toward the outside). This was also the case in the absorption column K10. For hydrostatic accumulation of the tray liquid, valve plate trays have at least one overflow weir with a downcomer. At four points on the periphery of the frequently circular lift cover, which are opposite one another like the ends of a cross, it is advantageously possible in application terms for small indentations to be made therein, which enable liquid to run off in the case of no loading (this was the case in the absorption column K10).

1500 mm above the 5th valve tray was the underside of the 6th valve tray, which formed part of a sequence of ten further valve trays of identical design. The uppermost of this valve tray sequence formed, overall, the 15th valve tray from the bottom upward. The equidistant separation of successive valve trays within this second sequence of valve trays was 600 mm, and the number of “valves/tray holes” was 5928 per tray. The diameter of the tray holes was again 39 mm. The arrangement of the centers thereof over a valve tray section again followed a regular triangular pitch. Valve trays 6 to 15 were configured as two-flow crossflow trays. The height of the overflow weirs on trays 6, 8, 10, 12 and 14 was 25 mm, and on trays 7, 9, 11, 13 and 15 it was 35 mm.

1500 mm above the 15th valve tray was the underside of a further chimney tray K2, which was likewise configured like the chimney trays disclosed in DE-A 10159825. The number of the chimneys on the chimney tray K2 was 16, the height thereof (calculated without roof) was 1500 mm and the internal diameter thereof was 797 mm. Like all chimney trays in the absorption column, the purpose of the chimney tray K2 was that of a collecting tray which is pervious only to ascending gas phase above the chimneys, and on which liquid descending in the absorption column accumulates and is conducted out of the absorption column by corresponding withdrawal.

About 800 mm above the chimney ends (calculated without roof) of the chimney tray K2 was the underside of the first of a further sequence of 9 valve trays. The equidistant separation thereof was 600 mm. The individual valve trays were configured as four-flow chimney trays. The number of “valves/tray holes” on trays 16, 18, 20, 22 and 24 was 5130 per tray. The number of “valves/tray holes” on trays 17, 19, 21 and 23 was 4958 per tray. The diameter of the tray holes on these valve trays was likewise 39 mm. The arrangement of the centers thereof again followed a regular triangular pitch per valve tray section. The height of the overflow weirs on trays 16, 18, 20, 22 and 24 was 20 mm. The height of the overflow weirs of trays 17, 19, 21 and 23 was 15 mm.

Above the valve tray 24, the absorption column began to narrow conically from the bottom upward (for instance at a length of approx. 1000 mm) until the internal diameter was 7000 mm, which was subsequently maintained up to the upper end of the column.

1400 mm above the valve tray 24 was the underside of the first valve tray of a further sequence of 14 valve trays (valve trays 25 to 38). They were likewise arranged equidistantly (600 mm) one on top of another and configured as two-flow crossflow trays. The number of “valves/tray holes” was 4188 per tray. The arrangement of the centers thereof again followed a regular triangular pitch per valve tray section. The height of the overflow weirs of trays 25, 27, 29, 31, 33, 35 and 37 was 35 mm. The height of the overflow weirs of trays 26, 28, 30, 32, 34, 36 and 38 was 25 mm.

2200 mm above the 38th valve tray was the underside of a further chimney tray K 3, which was likewise configured like the chimney trays disclosed in DE-A 10159825. The number of chimneys of the chimney tray K3 was 16, its height (without roof) was 1500 mm and its internal diameter was 598 mm.

The chimney tray K3 formed the end of the actual (in the sense of the invention) absorption section of the absorption column. The section above the chimney tray K3 formed a secondary column attached in the manner of DE-A 4436243 (a secondary section).

800 mm above the chimney ends (calculated without roof) of the chimney tray K3 was the underside of the first of a further sequence of 9 valve trays. They were configured as two-flow crossflow trays and arranged equidistantly (600 mm) one on top of another. The number of “valves/tray holes” was 4558 passage orifices per tray on trays 39 and 41. The number of “valves/tray holes” was 4484 passage orifices per tray on trays 40 and 42. On trays 43 to 47, the number of “valves/tray holes” was 4238 passage orifices per tray. The height of the overflow weirs on trays 39, 40, 41 and 42 was 50 mm. The height of the overflow weirs on trays 43, 45 and 47 was 40 mm, and on trays 44 and 46 it was 25 mm.

At a distance of 1000 mm from the uppermost valve tray (47th valve tray) was a support ring with a ring width of 500 mm. A wire braid lay thereon as a demister, which had a height (thickness) of 450 mm. An outlet stub in the upper torispherical end with an internal diameter of 3000 mm formed the outlet from the absorption column K10.

The absorption column was not thermally insulated from its environment. The material used for the manufacture thereof was the material 1.4571 (to DIN EN 10020). The wall thickness was 25 mm at the bottom and 16 mm at the top. Otherwise, the absorption was performed based on DE-A 4436243.

From the chimney tray K (T=113.8° C.; P=1.420 bar), by means of a pump P10, 1 560 475 kg/h of adsorbate A which accumulated on the chimney tray K was conducted out of the absorption column (the liquid level on all chimney trays of the absorption column was regulated by pressure differential measurement (cf. WO 03/076382) through open bores in the column wall (for safety reasons, two level measurements were always carried out simultaneously; the corresponding bores were opposite one another in pairs at the same height); one bore was above the liquid level and one was at the liquid level; the lines from the bores to the transducer (appropriately in application terms a membrane pressure load cell; it consists of two measurement chambers hermetically sealed from one another by a membrane; one measurement pressure is conducted into each corresponding measurement chamber; the resulting membrane bending reflects the pressure difference) were each purged with 80 to 100 l (STP)/h of molecular nitrogen (≦20 ppm by volume of O₂) at a temperature of 25° C.; gases comprising molecular oxygen, such as air or lean air, are unsuitable as purge gases here, since they, as a constituent of the residual gas stream leaving the absorption column, would at least partly be part of the cycle gas recycled into the gas phase oxidation and in this way would intervene in the determination of the oxygen content of the reaction gas mixture for the gas phase oxidation (the reaction gas mixture should always be outside the explosion range)), which had the following contents:

| | | |
|---|---|---|
| 30.792% | by wt. of | acrylic acid, |
| 0.151% | by wt. of | acetic acid, |
| 0.157% | by wt. of | water, |
| 53.507% | by wt. of | diphyl, |
| 13.268% | by wt. of | dimethyl phthalate, |
| 0.0011% | by wt. of | formic acid, |
| 0.0064% | by wt. of | acrolein, |
| 0.0066% | by wt. of | propionic acid, |
| 0.0128% | by wt. of | furfurals, |
| 0.0012% | by wt. of | allyl acrylate, |
| 0.163% | by wt. of | benzaldehyde, |
| 0.607% | by wt. of | maleic anhydride, |
| 0.230% | by wt. of | benzoic acid, |
| 1.014% | by wt. of | diacrylic acid, |
| 0.0291% | by wt. of | phenothiazine, and |
| 0.0002% | by wt. of | molecular oxygen. |

Still upstream of the pump P10, a small liquid return stream (3224 kg/h; 24° C.) RS from the region of the direct cooling of the vapor stream which leaves the rectification column which is yet to be described at the top thereof was supplied to the stream of adsorbate A withdrawn from the chimney tray K, and had the following contents:

| | | |
|---|---|---|
| 97.750% | by wt. of | acrylic acid, |
| 0.974% | by wt. of | acetic acid, |
| 1.134% | by wt. of | water, |
| 0.0001% | by wt. of | acrolein, |
| 0.0231% | by wt. of | propionic acid, |
| 0.0067% | by wt. of | furfurals, |
| 0.0162% | by wt. of | allyl acrylate, |
| 0.0006% | by wt. of | benzaldehyde, |
| 0.0005% | by wt. of | maleic anhydride, |
| 0.0150% | by wt. of | diacrylic acid, |
| 0.0284% | by wt. of | phenothiazine, and |
| 0.0007% | by wt. of | molecular oxygen |

(crude acrylic acid produced off-spec can, if required, likewise be fed back into the preparation process at this point).

This formed an overall stream of adsorbate N sucked in and delivered by the pump P10.

73 680 kg/h of the overall stream of adsorbate A⁺ was conveyed into the bottom space of the absorption column below the flat cone (“Chinese hat”) mounted in the bottom space of the absorption column (in order to keep the circulation rate of the direct cooling in a steady state). 228 919 kg/h of the overall stream of adsorbate A⁺ was fed as stream R^{A+} through the tubes of a tube bundle heat exchanger W18 heated with steam (160° C.; 6.2 bar) to the top of the stripping column K20 for the low boiler stripping. In the course of this, the temperature of this stream of adsorbate A⁺ increased to 122.3° C. The steam condensed in the heat exchanger W18 (condensate temperature=113° C.) was recycled into the grid for steam-raising. W18 was a four-pass tube bundle heat transferor with 184 transferor tubes of length 6000 mm and of internal diameter 34 mm (wall thickness=2 mm). The heat exchanger W18 was manufactured from 1.4571 material.

The remaining stream from the overall stream of adsorbate A⁺ was recycled via two indirect heat exchangers W14 and W10 (in that sequence) with a temperature of 108.9° C. into the absorption column at the 5th valve tray (from the bottom).

The heat exchanger W14 was a tube bundle heat exchanger. The cooling medium used was essentially aqueous extract from the acid water extraction which is still to be described hereinafter, which had a temperature of approx. 41° C. This heated the aqueous extract to 56° C. Just like a portion of the residual gas leaving the absorption column at the top thereof (i.e. at the top of the secondary column), it was sent to incineration (cf. DE-A 10336386, and also DE-A 19624674 and WO 97/48669). The energy balance of this incineration was improved by saturating the residual gas to be incinerated with the aforementioned aqueous extract prior to the incineration thereof (in the saturator column K14). This saturated the residual gas, more particularly, with water vapor. The evaporation of the latter in the course of incineration of the aqueous extract was thus dispensed with.

The heat exchanger W10 was an air cooler. This consisted essentially of a bundle of finned tubes within which the liquid to be cooled was conducted. With the aid of a ventilator below the tube bundle, air from the ambient atmosphere was conducted around the finned tubes as the cooling medium (approx. −10 to +35° C., according to ambient temperature).

From the chimney tray K2, by means of the pump P11, a further liquid stream was conducted continuously out of the absorption column. This was combined with the return stream of the condensed vapor, which is still to be described, from the distillation column (8642 kg/h; 40.5° C.) to give an overall stream.

The return stream of the vapor condensate had the following contents:

| | | |
|---|---|---|
| 4.346% | by wt. of | acrylic acid, |
| 0.0260% | by wt. of | acetic acid, |
| 0.0102% | by wt. of | water, |
| 56.46% | by wt. of | diphyl, |
| 37.279% | by wt. of | dimethyl phthalate, |
| 0.0003% | by wt. of | formic acid, |
| 0.0025% | by wt. of | acrolein, |
| 0.0007% | by wt. of | propionic acid, |
| 0.0024% | by wt. of | furfurals, |
| 0.0001% | by wt. of | allyl acrylate, |
| 0.0299% | by wt. of | benzaldehyde, |
| 0.141% | by wt. of | maleic anhydride, |
| 0.369% | by wt. of | benzoic acid, |
| 1.244% | by wt. of | diacrylic acid, |
| 0.004% | by wt. of | glyoxal, |
| 0.0333% | by wt. of | phenothiazine, and |
| 0.0001% | by wt. of | molecular oxygen. |

The overall stream (2 328 293 kg/h; 68.3° C.) had the following contents:

| | | |
|---|---|---|
| 36.668% | by wt. of | acrylic acid, |
| 3.205% | by wt. of | acetic acid, |
| 3.121% | by wt. of | water, |
| 43.203% | by wt. of | diphyl, |
| 11.424% | by wt. of | dimethyl phthalate, |
| 0.0052% | by wt. of | formic acid, |
| 0.0328% | by wt. of | acrolein, |
| 0.0035% | by wt. of | propionic acid, |
| 0.0076% | by wt. of | furfurals, |
| 0.0076% | by wt. of | allyl acrylate, |
| 0.142% | by wt. of | benzaldehyde, |
| 0.412% | by wt. of | maleic anhydride, |
| 0.186% | by wt. of | benzoic acid, |
| 1.50% | by wt. of | diacrylic acid, |
| 0.0308% | by wt. of | phenothiazine, and |
| 0.0008% | by wt. of | molecular oxygen. |

A substream of 282 793 kg/h of the overall stream was recycled as such to the 15th valve tray (from the bottom) of the absorption column.

The remaining residual stream (2 045 500 kg/h) of the overall stream was first conducted through the heat exchanger W11, which cooled it to 48.9° C.

The heat exchanger W11 was, like the heat exchanger W10, an air-cooled finned tube heat exchanger. Depending on the temperature of the ambient atmosphere, the temperature of the aforementioned residual stream can be adjusted if required, prior to the recycling thereof into the absorption column, beyond the heat exchanger W11, by supplying fresh absorbent to it (for example mixture G withdrawn from the buffer vessel B 8000).

The main stream of absorbent (161 090 kg/h) was fed to the absorption column at the 38th valve tray. This main stream was formed by a combination of two substreams. The first substream, substream I (134 949 kg/h; 55.6° C.), was a mixture of fresh absorbent and absorbent which was conducted out of the stripping section of the rectification column described below and comprised ≦1% by weight of acrylic acid, which mixture had, however, already been used to scrub a portion of the residual gas flowing out of the outlet stub of the absorption column in the scrubbing column K19, in order to very substantially free this portion of residues of acrolein, acetic acid and acrylic acid (in other words, it was a mixture G already employed in the scrubbing column K19). The residual gas thus scrubbed was subsequently used as stripping gas for the low boiler stripping which is still to be described.

Substream I had the following contents:

| | | |
|---|---|---|
| 0.992% | by wt. of | acrylic acid, |
| 0.0207% | by wt. of | acetic acid, |
| 0.173% | by wt. of | water, |
| 74.46% | by wt. of | diphyl, |
| 18.77% | by wt. of | dimethyl phthalate, |
| 0.0209% | by wt. of | acrolein, |
| 0.0002% | by wt. of | propionic acid, |
| 0.0101% | by wt. of | furfurals, |
| 0.198% | by wt. of | benzaldehyde, |
| 0.743% | by wt. of | maleic anhydride, |
| 0.323% | by wt. of | benzoic acid, |
| 4.181% | by wt. of | diacrylic acid, |
| 0.0543% | by wt. of | phenothiazine, and |
| 0.0007% | by wt. of | molecular oxygen. |

Substream II (26 141 kg/h; 47.7° C.) was a mixed stream which corresponded to substream I but which, in contrast to substream I, had additionally also been subjected to the extraction with acid water still to be described below after use for the residual gas scrubbing in the scrubbing column K19 (i.e. it was a stream of mixture G which had already been employed in the scrubbing column 19 and thereafter in the acid water extraction).

Substream II had the following contents:

| | | |
|---|---|---|
| 2.1311% | by wt. of | acrylic acid, |
| 0.443% | by wt. of | acetic acid, |
| 0.699% | by wt. of | water, |
| 75.18% | by wt. of | diphyl, |
| 18.41% | by wt. of | dimethyl phthalate, |
| 0.0327% | by wt. of | acrolein, |
| 0.0004% | by wt. of | propionic acid, |
| 0.0167% | by wt. of | furfurals, |
| 0.0002% | by wt. of | allyl acrylate, |
| 0.331% | by wt. of | benzaldehyde, |
| 0.301% | by wt. of | maleic anhydride, |
| 0.296% | by wt. of | benzoic acid, |
| 2.047% | by wt. of | diacrylic acid, and |
| 0.0535% | by wt. of | phenothiazine. |

The gas mixture which flows through the chimneys of the chimney tray K3 into the secondary column attached to the main column of the absorption column was subjected in this secondary section (in this secondary column) of the absorption column to the acid water condensation.

To this end, from the chimney tray K3, by means of the pump P12, 493 340 kg/h of liquid accumulating in biphasic form on the chimney tray K3 (of the “acid water”) was conducted continuously out of the secondary column (43.5° C.). This had the following contents:

| | | |
|---|---|---|
| 6.497% | by wt. of | acrylic acid, |
| 3.788% | by wt. of | acetic acid, |
| 50.22% | by wt. of | water, |
| 28.408% | by wt. of | diphyl, |
| 6.58% | by wt. of | dimethyl phthalate, |
| 2.25% | by wt. of | formic acid, |
| 0.026% | by wt. of | acrolein, |
| 0.0011% | by wt. of | propionic acid, |
| 0.0171% | by wt. of | furfurals, |
| 0.0020% | by wt. of | allyl acrylate, |
| 0.299% | by wt. of | benzaldehyde, |
| 0.926% | by wt. of | maleic anhydride, |
| 0.113% | by wt. of | benzoic acid, |
| 0.800% | by wt. of | diacrylic acid, |
| 0.0187% | by wt. of | phenothiazine, and |
| 0.0026% | by wt. of | molecular oxygen. |

476 570 kg/h of this withdrawn stream was conducted through the heat exchanger W12, which cooled it to 26.4° C. The heat exchanger W12 used was a two-pass tube bundle heat transferor which was cooled with river water and had 2414 transferor tubes of length 6000 mm and of internal diameter 16 mm (wall thickness=2 mm), which was manufactured from 1.4571 material.

247 300 kg/h of the aforementioned stream cooled to 26.4° C. was introduced to the 42nd valve tray of the absorption column K10 via slotted inserted tubes with substantial prevention of droplet formation.

The remaining 229 270 kg/h of the aforementioned stream cooled to 26.4° C. was conducted through a further heat exchanger W4, which cooled it to 14.7° C.

Subsequently, it was introduced immediately above the 47th valve tray (from the bottom) by means of slotted inserted tubes with substantial prevention of droplet formation thereof. The heat exchanger W4 was an eight-pass tube bundle heat transferor with 1510 transferor tubes of length 5000 mm and internal diameter 21 mm (wall thickness=2 mm). The coolant used was liquid propylene (purity: chemical grade) (−5 to +3° C.), which was conducted out of the corresponding storage tank through the secondary space, surrounding the heat exchanger tubes, of the heat exchanger W4. The propylene which leaves the secondary space in gaseous form with a temperature of +10 to +13° C. was subsequently sent to the preparation of the reaction gas mixture (cf. also EP-A 1097916).

16 770 kg/h of the acid water conducted out of the absorption column from the chimney tray K3 was sent to the extraction of the substream II* with acid water, which is detailed later in this document.

Through the outlet stub in the upper dished end (torispherical end) of the absorption column flowed 277 120 kg/h (27.4° C.; 1.08 bar) of residual gas which consisted predominantly of uncondensables out of the absorption column. The residual gas stream had the following contents:

| | | |
|---|---|---|
| 0.105% | by wt. of | acrylic acid, |
| 0.0831% | by wt. of | acetic acid, |
| 2.027% | by wt. of | water, |
| 0.0099% | by wt. of | diphyl, |
| 0.0003% | by wt. of | dimethyl phthalate, |
| 0.0845% | by wt. of | acrolein, |
| 0.0005% | by wt. of | furfurals, |
| 0.0013% | by wt. of | benzaldehyde, |
| 0.0005% | by wt. of | maleic anhydride, |
| 4.69% | by wt. of | molecular oxygen, |
| 2.39% | by wt. of | carbon dioxide, |
| 0.750% | by wt. of | carbon monoxide, |
| 0.547% | by wt. of | propane, |
| 0.273% | by wt. of | propylene, and |
| 88.97% | by wt. of | molecular nitrogen. |

The residual gas stream was conducted through the heat exchanger W13, which heated it to 28.2° C. (this counteracted undesired condensate formation in the residual gas stream on the further flow path thereof). The heat exchanger W13 was a single-flow tube bundle heat transferor with 1330 transferor tubes of length 500 mm and of internal diameter 56.3 mm (wall thickness=2 mm). The heat carrier conducted around the transferor tubes in the secondary space was steam.

The steam was fed in at a temperature of 160° C. and a pressure of 6.2 bar.

160 968 kg/h of the residual gas stream heated to 28.2° C. was subsequently compressed with a radial compressor V1 (manufacturer: Borsig, model: GA 1180/1) to a pressure of 2.38 bar (this increased the temperature to 127° C.). 122 683 kg/h of the residual gas stream thus compressed was recycled as cycle gas to the formation of the reaction gas mixture (5.8% by volume of propylene (chemical grade), 49.6% by volume of cycle gas and 44.6% by volume of air) for the two-stage partial oxidation of propylene to acrylic acid.

38 285 kg/h of the residual gas stream compressed as described were sent to the scrubbing thereof in the scrubbing column K19.

The remaining stream of 116 152 kg/h of residual gas heated to 28.2° C. was compressed with a radial blower V14 (manufacturer: DSD, model: DRMU 1120 K) to 1.12 bar (this increased the temperature to 39° C.) and sent to the saturator column K14.

The scrubbing column K19 had an internal diameter of 2500 mm and a height of 17 400 mm. As separating internals, it comprised 30 dual-flow trays. The hole diameter thereof was a uniform 30 mm. They were distributed homogeneously in strict triangular pitch over the particular tray. Their equidistant separation was 400 mm. The lowermost dual-flow tray was at a height of 4000 mm. The number of passage orifices per tray was 1453.

The compressed residual gas stream to be scrubbed was conducted into the column K19 below the lowermost tray but above the liquid level.

The liquid level in the column K19 was regulated by the pressure differential method (cf. WO 03/076382). One of the two corresponding bores was below the lowermost tray but above the liquid level, and the other was above the lower torispherical end in the cylindrical section below the minimum permissible liquid level. Each of the two bores was purged with 80 to 100 l (STP)/h of molecular nitrogen (≦20 ppm by volume of O₂). For safety reasons, each pressure differential measurement was implemented in the form of mutually opposite duplicates.

The scrubbing liquid used was the mixture G. It consisted of absorbent which was conducted out of the rectification column K30 below the lowermost tray and comprised ≦1% by weight of acrylic acid (liquid F) and of fresh absorbent (mixture diphyl and dimethyl phthalate in a weight ratio of 4:1), the addition of which compensated for (replaced) corresponding process losses. The replacement was undertaken in a buffer vessel B 8000 (for homogenization), from which the mixture G was withdrawn continuously.

The liquid F (160 043 kg/h) which was conducted out of the column K30 with a temperature of 188° C. was cooled (to 37° C.) prior to the use thereof for preparing the mixture G. For this purpose, it flowed, as a heat carrier, through the secondary spaces of various heat exchangers, within the primary spaces of which other process streams were conducted in order to supply the thermal energy to be released by the liquid F thereto.

First, the liquid F flowed through the two heat exchangers W22 and W21 which were connected in series in this sequence with respect to the liquid F. The bottoms liquid withdrawn from the stripping column K20 functioned as the coolant, with respect to which the heat exchangers W22 and W21 were connected in parallel.

Both heat exchangers W21 and W22 were spiral heat exchangers. In the heat exchanger W22, the liquid F was cooled to 186.1° C., and was cooled further in the heat exchanger W21 to 145.9° C. In the heat exchangers W25 and W26 (connected in series in this sequence) through which the liquid F subsequently flowed, feed water was the coolant in each case.

A total of 154 592 kg/h of mixture G with a temperature of 39.8° C. were introduced at the top of the scrubbing column K19. It was introduced via an inserted tube which projected into the middle of the column. Its internal diameter was 261.8 mm with a wall thickness of 5.6 mm. Below the outlet at the top of the scrubbing column K19 was again mounted a demister (droplet precipitator).

The scrubbed residual gas leaving the scrubbing column K19 at the top thereof (37 928 kg/h; 42.2° C.; 2.097 bar) had the following contents:

| | | |
|---|---|---|
| 0.0251% | by wt. of | acrylic acid, |
| 1.340% | by wt. of | H₂O, |
| 0.0196% | by wt. of | diphenyl, |
| 0.0009% | by wt. of | dimethyl phthalate, |
| 0.0002% | by wt. of | furfurals, |
| 0.0023% | by wt. of | benzaldehyde, |
| 0.0079% | by wt. of | maleic anhydride, |
| 4.741% | by wt. of | molecular oxygen, |
| 2.41% | by wt. of | carbon dioxide, |
| 0.757% | by wt. of | carbon monoxide, |
| 0.552% | by wt. of | propane, |
| 0.276% | by wt. of | propylene, and |
| 89.81% | by wt. of | molecular nitrogen. |

For the purpose of low boiler stripping, it was fed as stripping gas to the stripping column K20. The scrubbing performed beforehand in the scrubbing column K19 removes undesired low-boiling secondary components (e.g. acrolein) from the stripping gas and increases the stripping efficiency. The material of manufacture of K19 was 1.4571 material.

The pump 19 was used, at the lower end of the scrubbing column K19, to withdraw 154 949 kg/h of the liquid descending within the column (at a temperature of 55.6° C.). 134 949 kg/h thereof were, as already described, recycled as substream I into the absorption column.

The remaining 20 000 kg/h of the liquid stream withdrawn with the pump 19 were sent as substream II* to the extraction with the 16 770 kg/h of acid water originating from the chimney tray K3 (43.5° C.).

To mix the two phases, the procedure may be as in DE-A 19631628. The subsequent phase separation can be effected as described in DE-A 19631662. The aqueous extract which results in the extraction unit has absorbed polar constituents such as diacrylic acid (Michael adduct) and maleic anhydride from the substream II*. This hydrolyzes the latter.

For reasons of technological simplicity, the mixing of the two liquid streams in the present example was, however, performed in a tube of length=5000 mm and internal diameter=163.1 mm. The two relevant liquid streams were pumped through the horizontal tube (which was thermally insulated; wall thickness=2.6 mm; 1.4571 material) in cocurrent and mixed with one another in the process.

In two separating vessels connected in series according to DE-A 19631662, the biphasic mixture was separated with a total residence time of 35 min into the aqueous extract and into the organic phase. The organic phase was, as already described, recycled as substream II into the absorption column.

The aqueous extract (10 629 kg/h; 47.7° C.) had the following contents:

| | | |
|---|---|---|
| 6.875% | by wt. of | acrylic acid, |
| 4.925% | by wt. of | acetic acid, |
| 77.45% | by wt. of | water, |
| 0.0300% | by wt. of | diphyl, |
| 0.420% | by wt. of | dimethyl phthalate, |
| 3.55% | by wt. of | formic acid, |
| 0.0012% | by wt. of | propionic acid, |
| 0.0048% | by wt. of | furfurals, |
| 0.0028% | by wt. of | allyl acrylate |
| 0.0301% | by wt. of | benzaldehyde, |
| 0.0570% | by wt. of | benzoic acid, |
| 2.507% | by wt. of | maleic acid, |
| 4.094% | by wt. of | diacrylic acid, and |
| 0.0054% | by wt. of | molecular oxygen. |

Together with 316 200 kg/h of liquid which descended within the saturator column K14 and was conducted out of it at the lower end thereof (39.8° C.), it was (as already described) conducted through the heat exchanger W14 as cooling liquid, which heated it to 50.4° C.

The mixture at 50.4° C. was subsequently introduced via an overflow distributor in the top space of the saturator column K14 like a “scrubbing liquid”.

The saturator column K14 was a column with random packing, charged with Pall VST rings, manufacturer: Vereinigte Füllkörper Fabriken, material: polypropylene. The total length of the saturator column K14 was 13 200 mm and the internal diameter thereof was 4200. The material of manufacture was 1.4571 material, with a wall thickness of 7 mm. The saturator column K14 was thermally insulated from the environment with 100 mm of mineral wool. The height of the bed of random packing was 4000 mm.

In countercurrent to the “scrubbing liquid”, below the bed of random packing but above the liquid level in the saturator column K14, the already described 116 152 kg/h of residual gas which had been compressed to 1.12 bar and had a temperature of 39° C. were conducted into the saturator column K14.

The liquid level was regulated as in column K19 by the pressure differential method.

At the lower end of the saturator column K14, 321 501 kg/h of liquid which descended within the saturator column K14 were constantly conducted out (39.8° C.). It had the following contents:

| | | |
|---|---|---|
| 7.88% | by wt. of | acrylic acid, |
| 5.73% | by wt. of | acetic acid, |
| 72.07% | by wt. of | water, |
| 0.0554% | by wt. of | diphyl, |
| 0.789% | by wt. of | dimethyl phthalate, |
| 0.0051% | by wt. of | formic acid, |
| 0.0175% | by wt. of | acrolein, |
| 0.0013% | by wt. of | propionic acid, |
| 0.0035% | by wt. of | furfurals, |
| 0.0038% | by wt. of | allyl acrylate, |
| 0.0198% | by wt. of | benzaldehyde, |
| 0.0116% | by wt. of | maleic anhydride, |
| 0.114% | by wt. of | benzoic acid, |
| 5.028% | by wt. of | maleic acid, |
| 8.209% | by wt. of | diacrylic acid, and |
| 0.0043% | by wt. of | molecular oxygen. |

5301 kg/h of the liquid which descended from the saturator column K14 and was conducted out at the lower end thereof was sent to incineration (cf. WO 97/48669, DE-A 10336386 and DE-A 19624674).

Sent to incineration in the same manner was the steam-saturated gas stream conducted out of the saturator column K14 at the top (121 480 kg/h; 48.4° C.; 1.25 bar), which had the following contents:

| | | |
|---|---|---|
| 0.358% | by wt. of | acrylic acid, |
| 0.260% | by wt. of | acetic acid, |
| 5.57% | by wt. of | water, |
| 0.0097% | by wt. of | diphyl, |
| 0.0025% | by wt. of | dimethyl phthalate, |
| 0.310% | by wt. of | formic acid, |
| 0.080% | by wt. of | acrolein, |
| 0.0001% | by wt. of | propionic acid, |
| 0.0008% | by wt. of | furfurals, |
| 0.0001% | by wt. of | allyl acrylate, |
| 0.0030% | by wt. of | benzaldehyde, |
| 4.49% | by wt. of | molecular oxygen, |
| 2.28% | by wt. of | carbon dioxide, |
| 0.717% | by wt. of | carbon monoxide, |
| 0.523% | by wt. of | propane, |
| 0.261% | by wt. of | propylene, and |
| 85.07% | by wt. of | molecular nitrogen. |

As it flows through the heat exchanger W15 (a single-pass tube bundle heat exchanger with 538 tubes of length 1500 mm and internal diameter 56.3 mm), through which steam flows as a heat carrier, the gas stream was heated to 78° C. prior to the combustion thereof.

8902 kg/h (152.4° C.) of the liquid which was delivered by the pump P9 and comprised the bottoms liquid which was withdrawn from the bottom space of the absorption column K10 and was relevant in accordance with the invention, 1 120 430 kg/h of which were sent to the direct cooler K9 for direct cooling of the product gas mixture of the propylene gas phase oxidation, were sent to the distillation unit relevant in accordance with the invention as liquid D to be distilled.

The circulation heat exchanger W40 which formed part of the distillation unit was a forced circulation flash heat exchanger. It was an eight-pass tube bundle heat transferor which comprised 704 heat transferor tubes. The internal diameter of the tubes was a uniform 21 mm, with a wall thickness of 2 mm and a tube length of 2500 mm. The material of manufacture was 1.4571 material. The internal diameter of the circular cylindrical heat transferor was 1100 mm. The heat carrier supplied to the heat transferor was 1800 kg/h of saturated steam (29 bar, 231° C.). By means of 7 circular deflecting plates (the ratio of free cross section to closed cross section thereof was in each case 3:8), the steam stream was conducted around the transferor tubes in the tube bundle heat transferor. The steam condensate which formed in the heart transferor was conducted out of the heat transferor at a temperature of 200° C.

The delivery pump P40 which accomplished the forced circulation was a radial centrifugal pump with a closed radial impeller from Sulzer, of the ZE 200/400 model. The barrier liquid used was a mixture of 50% by weight of glycol and 50 by weight of water. The throttle device used was a perforated plate. The cross-sectional widening in flow direction was from 49 063 to 196 250 mm². The perforated plate was about 3.4 m upstream of the reentry into the distillation column in flow direction.

The distillation column had a cylindrical cross section with an internal diameter of 2200 mm. The height of the cylindrical section was 7402 mm. The material of manufacture was 1.4571 material; the wall thickness was 12 mm. The internal diameter of the upper outlet stub was 900 mm; the diameter of the lower outlet stub was 400 mm. The upper outlet stub was conducted into the distillation column to a length of 558 mm. Additionally mounted around this stub conducted into the column was a circular collar projecting downward from the upper end of the distillation column, the collar length of which was 500 mm. The top pressure of the distillation column was set to 85 mbar (as always in this document, unless explicitly stated otherwise, to be understood as working pressure (absolute pressure)). The distillation column was operated without reflux liquid (in contrast to a rectification column). The distillation unit was operated under level control. The maximum level of the liquid accumulated at the lower end of the distillation column (of the accumulated concentrate) was 1932 mm and the minimum level was 900 mm. The liquid D to be distilled was fed into the distillation column cyclically in the corresponding manner. It was also fed into the superheated stream leaving the forced circulation flash evaporator, specifically beyond the throttle but upstream of the tangential inlet of the mixed stream into the distillation column in flow direction thereof. The tangential inlet passed through a cuboidal inlet slot. This possessed a width of 1875 mm and a depth of 365 mm. Its height extended over a longitudinal section of the column of 2075 mm. The middle of this longitudinal section was at a column height (from the bottom) of 3563 mm. The pressure at the outlet of the forced circulation flash evaporator was approx. 4 bar.

Through the top of the upper outlet stub of the distillation column, 8642 kg/h of vapor formed in the column was conducted out at a temperature of 180° C. It was condensed as it passed through an air-cooled finned tube heat exchanger and sent to the buffer vessel VB 40. As already described, the vapor condensate was recycled from the latter into the absorption column K10 at a temperature of 40.5° C. (recycle stream of the vapor condensate: 8642 kg/h).

The flow M of the liquid concentrate withdrawn from the lower outlet stub of the distillation column with the temperature T¹=180° C. by the delivery pump P40 was 204 176 kg/h. A substream T^{AU} of 260 kg/h thereof was discharged. The remaining residual stream R^{M}=203 916 kg/h of stream M was conducted through the forced circulation flash evaporator W40. The temperature T² with which this stream left the forced circulation flash evaporator again was 189° C.

The volume V^{Z} of the feed line (including the delivery pump P40) through which the residual stream R^{M} was conveyed to the circulation heat exchanger W40 was 6.6 m³.

The volume V^{R} of the recycle line through which the superheated residual stream R^{M} was recycled from the circulation heat exchanger W40 into the distillation column was 1.8 m³. The volume V^{P} (=the total volume of the internal volumes of the heat transferor tubes) was 1.3 m³, and the volume V^{K} of the concentrate level in the distillation column was, averaged over one cycle duration, 2.7 m³. This gave a V^{G}=V^{K}+V^{Z}+V^{P}+V^{R} of 12.4 m³. From the substream T^{Au} of 260 kg/h, with the density ρ=1135 kg/m³ of the discharge stream, a flow \dot{T}^{Au} thereof of 0.229 m³/h is calculated. Division of V^{G} by \dot{T}^{Au} results in a mean residence time t^{V} of 54.15 h.

The contents of liquid concentrate were:

| | | |
|---|---|---|
| 0.146% | by wt. of | acrylic acid, |
| 0.0004% | by wt. of | acetic acid, |
| 32.94% | by wt. of | diphyl, |
| 57.13% | by wt. of | dimethyl phthalate, |
| 0.0001% | by wt. of | furfurals, |
| 0.0024% | by wt. of | benzaldehyde, |
| 0.0133% | by wt. of | maleic anhydride, |
| 0.258% | by wt. of | benzoic acid, |
| 0.955% | by wt. of | diacrylic acid, and |
| 8.50% | by wt. of | phenothiazine. |

The stripping column K20 was a cylindrical column with an internal diameter of 4500 mm and a length of 28 280 mm. As separating internals, it comprised mass transfer trays. Trays 1 to 8 from the bottom were dual-flow trays. The equidistant tray separation thereof was 700 mm. The number of passage orifices per dual-flow tray was 4053. The diameter of one passage orifice was 30 mm. The passage orifices were distributed according to strict triangular pitch over one dual-flow tray. The lowermost dual-flow tray was at a height of 4820 mm (measured from the lowest point in the column).

1100 mm above the 8th dual-flow tray from the bottom was the underside of the first valve tray within a sequence of a total of 30 valve trays (trays 9 to 38 from the bottom). They were (valve plate trays (the plate thickness was, correspondingly to the valve trays of the absorption column K10, 2 or 1.5 mm) from Koch International with type Q-7-U, valves, diameter of the tray holes=39 mm) arranged equidistantly one on top of another with a separation of 500 mm. The valve trays were configured as two-flow crossflow trays. The number of “valve/tray holes” was 1536 per tray. The arrangement of the centers thereof followed a regular triangular pitch per valve tray section.

The 37 928 kg/h (73.2° C.; 2.2 bar) of stripping gas were fed to the stripping column K20 below the lowermost dual-flow tray thereof and above the liquid level therein. The liquid level was regulated as in column K19 by the pressure differential method. The stripping column K20 was manufactured from 1.4571 material and thermally insulated from the ambient atmosphere.

The 228 919 kg/h of the adsorbate A⁺ to be stripped (122.3° C.) were fed to the stripping column K20 above the uppermost valve tray by means of a slotted inserted tube with an internal diameter of 261.8 mm.

78 318 kg/h (118.7° C.; 1.52 bar) of stripping gas laden with low boilers left the stripping column K20 at the top thereof and were, as already described, conducted into the direct cooler K9.

At the lower end of the stripping column K20, the radial centrifugal pump P20 (closed impeller, model: SVN 12×22, manufacturer: Ruhrpumpen, barrier liquid: 50% by volume of glycol/50% by volume of water) was used to conduct 1 177 087 kg/h (122.4° C.) of the adsorbate A* depleted of low boilers out of the stripping column K20.

This was divided into three streams A, B and C. Stream A was 771 207 kg/h. Stream B was 196 100 kg/h. Stream C was 209 780 kg/h.

The three streams were conveyed parallel to one another through the heat exchanger W20 (stream A), W21 (stream B) and W22 (stream C). The latter two have already been described.

Stream B left the heat exchanger W21 at a temperature of 123.9° C. Stream C left the heat exchanger W22 at a temperature of 152.5° C. 193 580 kg/h of the stream C heated to 152.5° C. were sent to the rectification column K30, such that a stream C* of 16 200 kg/h at the temperature of 152.5° C. remained.

Stream A was conveyed through the transferor tubes of a forced circulation tube bundle heat exchanger W20 which was heated with saturated steam (6.2 bar, 160° C.) (the steam condensate was conducted out of W20 at 125° C.). W20 was a six-pass tube bundle heat transferor which comprised 194 heat transferor tubes. Its internal diameter was a uniform 26 mm, with a wall thickness of 2 mm and a tube length of 6000 mm (1.4571 material). Stream B left the heat exchanger W20 at a temperature of 132.2° C.

The heated streams A and B, and stream C* were combined to form a common stream (983 507 kg/h; 130.9° C.) and recycled via a liquid distributor into the stripping column to the 8th dual-flow tray from the bottom.

The contents of the adsorbate A* were:

| | | |
|---|---|---|
| 18.40% | by wt. of | acrylic acid, |
| 0.0328% | by wt. of | acetic acid, |
| 0.0197% | by wt. of | water, |
| 61.77% | by wt. of | diphyl, |
| 15.48% | by wt. of | dimethyl phthalate, |
| 0.0045% | by wt. of | propionic acid, |
| 0.0123% | by wt. of | furfurals, |
| 0.0007% | by wt. of | allyl acrylate |
| 0.165% | by wt. of | benzaldehyde, |
| 0.619% | by wt. of | maleic anhydride, |
| 0.267% | by wt. of | benzoic acid, |
| 3.14% | by wt. of | diacrylic acid, |
| 0.0341% | by wt. of | phenothiazine, and |
| 0.0003% | by wt. of | molecular oxygen. |

The rectification column K30 was a tray column which comprised exclusively dual-flow trays as separating internals. The internal diameter of the column was 4600 mm and the height of the column K30 was 32 790 mm.

The column K30 comprised a total of 46 dual-flow trays.

The lowermost dual-flow tray was at a column height of 9586 mm. The dual-flow trays 1 to 8 formed a first series of trays arranged one on top of another equidistantly at a separation of 400 mm. The number of passage orifices per dual-flow tray was 1506 on trays 1 and 2 with an orifice diameter of 50 mm. The number of passage orifices of trays 3 to 6 was 1440 with an orifice diameter of 50 mm per passage orifice, and the number of passage orifices on trays 7 and 8 was 1460 at a diameter of 50 mm per passage orifice. The relative arrangement of the passage orifices in each case followed a strict triangular pitch.

The clear distance between tray 8 (from the bottom) and tray 9 (from the top) was 1000 mm. The 9th dual-flow tray was the first tray of a second series of dual-flow trays likewise arranged one on top of another equidistantly at a distance of 400 mm. This second series comprised a total of 38 dual-flow trays.

The number of passage orifices of tray 9 was 1002 with a diameter of 50 mm per passage orifice. Tray 10 had 4842 passage orifices with a diameter of 25 mm per orifice. Trays 11 and 12 had a number of 4284 passage orifices each with a diameter of 25 mm per passage orifice. The number of passage orifices of tray 13 was 4026 orifices with a diameter of 25 mm per passage orifice. The number of passage orifices of trays 14 to 28 was in each case 12 870 with an orifice diameter of 14 mm per tray. Trays 29 to 31 had a number of 13 632 passage orifices with a diameter of 14 mm per passage orifice. Tray 32 had a number of 14 361 passage orifices with a diameter of 14 mm per passage orifice. Trays 33 to 39 had a number of 14 365 passage orifices per tray with a diameter of 14 mm per passage orifice. Tray 40, which is the draw tray (see below), had a number of 14 362 passage orifices with a diameter of 14 mm per orifice. Trays 41 to 46 had a number of passage orifices of 14 577 per tray with a diameter of 14 mm per passage orifice.

The 193 580 kg/h of the adsorbate A* heated to 152.5° C. were fed to the rectification column through 6 baffle plate nozzles mounted on the circumference of the column (in analogy to those already disclosed in EP-A 1345881) at the 8th dual-flow tray (from the bottom).

Below the lowermost dual-flow tray but above the liquid level in the column K30, 1091 kg/h of air (water content=0.4369% by weight, temperature=20° C.) were conducted into the separating column. The pressure at the top of the column was 107 mbar. The pressure below the lowermost tray and above the liquid level was 278 mbar. The liquid level was regulated as in column K19 by the pressure differential method. However, the purge gas used was air at 25° C. Alternatively, lean air could also be used for this purpose. This is nitrogen-diluted air. The oxygen content of lean air is about 5% by volume of O₂.

The energy was supplied by means of the forced circulation tube bundle heat transferor W30. To this end, 1 155 440 kg/h of the liquid were conducted with the radial centrifugal pump P30 out of the separating column K30 below the lowermost separating tray (188 to 193° C.). 160 043 kg/h of this liquid stream were, as already described, recycled into the absorption process as liquid F.

The remaining 995 397 kg/h were recycled with the pump P30 through the heat transferor W30 into the separating column K30 (at a temperature of 197.2° C.). The recycling was effected below the lowermost separating tray but above the liquid level in the separating column K30 (advantageously, the recycling can be effected via a feed curved downward onto a baffle plate mounted below the lowermost separating tray but above the liquid level of the separating column K30 (cf. DE-A 10 2004015727)). The pump P30 had a closed impeller. The barrier liquid used was a mixture of 50% by weight of glycol and 50% by weight of water. The pump P30 was of the SVN 12×22 type from Ruhrpumpen.

The heat exchanger W30 was an eleven-flow tube bundle heat transferor which comprised 2911 heat transferor tubes. The internal diameter of the tubes was a uniform 20 mm with a wall thickness of 2 mm and a tube length of 5000 mm. The material of manufacture was, as for column K30 which was thermally insulated from the environment, 1.4571 material. The internal diameter of the circular cylindrical heat transferor was 2540 mm and its wall thickness was 30 mm. The heat carrier supplied was 22 000 kg/h of saturated steam (226° C., 29 bar). The steam condensate which forms in the heat transferor was conducted out of the latter at a temperature of 206° C. By means of 6 circular deflecting plates (the ratio of free cross section to closed cross section thereof was 1:126 in each case), the water vapor stream was conducted around the transferor tubes in the tube bundle heat transferer.

The throttle device used in the forced circulation flash evaporation was a perforated plate (the circular plate orifice had a diameter of 308.5 mm, while the internal diameter of the delivery tube equipped with the perforated plate was 603.6 mm).

The liquid F had the following contents:

| | | |
|---|---|---|
| 0.976% | by wt. of | acrylic acid, |
| 0.0001% | by wt. of | acetic acid, |
| 74.72% | by wt. of | diphyl, |
| 18.72% | by wt. of | dimethyl phthalate, |
| 0.0001% | by wt. of | propionic acid, |
| 0.01% | by wt. of | furfurals, |
| 0.199% | by wt. of | benzaldehyde, |
| 0.747% | by wt. of | maleic anhydride, |
| 0.324% | by wt. of | benzoic acid, |
| 4.20% | by wt. of | diacrylic acid, and |
| 0.0545% | by wt. of | phenothiazine. |

At the top of K30, a vapor stream (73 991 kg/h; 107 mbar; 78.7° C.) left the latter, and had the following contents:

| | | |
|---|---|---|
| 97.31% | by wt. of | acrylic acid, |
| 0.711% | by wt. of | acetic acid, |
| 0.416% | by wt. of | water, |
| 0.023% | by wt. of | propionic acid, |
| 0.0067% | by wt. of | furfurals, |
| 0.0124% | by wt. of | allyl acrylate, |
| 0.0005% | by wt. of | benzaldehyde, |
| 0.0003% | by wt. of | maleic anhydride, and |
| 0.3788% | by wt. of | molecular oxygen. |

This stream was subjected to condensation in two direct coolers B34 and B35 which were outside the column K30 and were connected in series, for the purpose of forming reflux liquid (the level in the condensation circuits was controlled by the pressure differential method; this was in each case implemented in duplicate, and the purge gas used was 80 to 100 l (STP)/h of air at 25° C. per bore). The cooling liquid used was in each case condensate which had been formed beforehand and circulated through a spiral heat exchanger in each case for the purpose of cooling, which had been supplemented in each case by a solution of phenothiazine in crude acrylic acid withdrawn beforehand from column K30.

The cooling liquid sprayed in the direct cooler B34 first in the flow sequence (34.4° C.; 961 965 kg/h) had the following contents:

| | | |
|---|---|---|
| 98.89% | by wt. of | acrylic acid, |
| 0.634% | by wt. of | acetic acid, |
| 0.325% | by wt. of | water, |
| 0.0238% | by wt. of | propionic acid, |
| 0.0080% | by wt. of | furfurals, |
| 0.0112% | by wt. of | allyl acrylate, |
| 0.0008% | by wt. of | benzaldehyde, |
| 0.0007% | by wt. of | maleic anhydride, |
| 0.0100% | by wt. of | diacrylic acid, |
| 0.0500% | by wt. of | phenothiazine, and |
| 0.0003% | by wt. of | molecular oxygen. |

Above the 46th dual-flow tray (from the bottom), 84 890 kg/h of reflux liquid having a temperature of 50.9° C. were conducted out of the liquid efflux in the direct cooler B34 into the rectification column K30. This had the following contents:

| | | |
|---|---|---|
| 98.89% | by wt. of | acrylic acid, |
| 0.636% | by wt. of | acetic acid, |
| 0.325% | by wt. of | water, |
| 0.0238% | by wt. of | propionic acid, |
| 0.0079% | by wt. of | furfurals, |
| 0.0113% | by wt. of | allyl acrylate, |
| 0.0008% | by wt. of | benzaldehyde, |
| 0.0006% | by wt. of | maleic anhydride, |
| 0.01% | by wt. of | diacrylic acid, |
| 0.046% | by wt. of | phenothiazine, and |
| 0.0003% | by wt. of | molecular oxygen. |

The cooling liquid sprayed in the direct cooler B35 next in the flow sequence (55 400 kg/h; 18.7° C.) had the following contents:

| | | |
|---|---|---|
| 97.75% | by wt. of | acrylic acid, |
| 0.679% | by wt. of | acetic acid, |
| 1.135% | by wt. of | water, |
| 0.0001% | by wt. of | acrolein, |
| 0.0232% | by wt. of | propionic acid, |
| 0.0067% | by wt. of | furfurals, |
| 0.0161% | by wt. of | allyl acrylate, |
| 0.0006% | by wt. of | benzaldehyde, |
| 0.0005% | by wt. of | maleic anhydride, |
| 0.0148% | by wt. of | diacrylic acid, |
| 0.0291% | by wt. of | phenothiazine, and |
| 0.0034% | by wt. of | molecular oxygen. |

From the liquid efflux in the direct cooler B35, 3224 kg/h (24° C.) were conducted as return stream RS, as already described, upstream of pump P10.

The spiral heat exchanger W34 which forms part of the direct cooler B34 was cooled with river water. The spiral heat exchanger W35 which forms part of the direct cooler B35 was cooled with cooling brine.

The reduced pressure in the rectification column K30 was established by means of a Siemens Elmo F liquid-ring compressor which took up the components which do not condense in the direct cooler B35.

The ring liquid used was a substream of the liquid which flows out of the spiral heat exchanger W35 and is cooled therein for the subsequent direct cooling. In a downstream separator, which was configured like a cyclone separator (manufacturer: Walter Kramer GmbH, internal diameter 2000 mm, height 4000 mm, wall thickness 6 mm), the ring liquid was separated from the uncondensed components and recycled upstream of the spiral heat exchanger. The uncondensed components were sent to incineration as a gas stream.

The dual-flow tray 40 in the rectification column K30 was configured as a side draw tray. In other words, it had a trough (a middle draw cup) in the middle, from which liquid accumulating therein was drawn off. This liquid conducted out of the column K30 from tray 40 was crude acrylic acid (85.2° C., 33 560 kg/h).

The middle draw cup had the following dimensions: width 440 mm, length 810 mm and depth 198.5 mm. The longitudinal edges of the cup base were, appropriately in application terms, rounded off for runoff reasons, such that the cross section of the middle draw cup was akin to a Latin “U”. The cup base such as twelve circular bores with an internal diameter of in each case 8 mm. Based on the essentially rectangular top view of the cup base, a bore was present in each corner of the rectangle (the distance of the center of such a corner bore to the 440 mm-wide transverse edge and to the 810 mm-long longitudinal edge was in each case 30 mm). Of the remaining eight bores, four each lay with their centers on a line which ran parallel to the longitudinal edges. The distance of the two lines from one another was 150 mm, and the distance of the particular line to the next closest longitudinal edge in each case was 145 mm. The distance between the centers of two successive bores on one line in the longitudinal direction thereof was 120 mm. The distance of the center of the bore closest to the transverse edge on a line was 225 mm. The surface of the cup base, moreover, was not entirely planar. Instead, it ascended slightly proceeding from the particular transverse edge toward the middle (the gain was about 50 millimeters in height), such that an apex ran parallel to the two transverse edges for half the length of the longitudinal edge. In each of the two transverse edges, a draw line was mounted in the middle, through which the crude acrylic acid was drawn off by means of a common pump. The gentle slope existing proceeding from the center line of the cup base toward each of the two transverse edges promotes the runoff of liquid toward the two outlets. This slope additionally achieves the effect that a portion of the liquid flowing through the bores runs on the lower surface of the draw cup, which constantly wets it, which counteracts undesired formation of polymer. The other portion of the liquid which runs through the bores drips directly downward, which brings about fluid-dynamic gas entrainment, which generates a desired gas circulation. In each of the two draw lines was mounted an inserted tube, through which crude acrylic acid at a temperature of 25° C. (inhibited with phenothiazine and withdrawn at an earlier time) was metered in. This direct cooling measure reduced the temperature of the crude acrylic acid flowing into the two draw lines immediately to approx. 75° C., which prevented boiling thereof (boiling gas conditions would counteract the intended flow). The two draw lines were subsequently merged using a Y-piece. Immediately beyond the Y-piece (in flow direction), air was additionally supplied (approx. 25° C.), in order to enhance the inhibition of polymerization. The air flow rate was such that the liquid stream just became saturated with air. Bubble formation should be avoided at this point.

The acrylic acid stream withdrawn was cooled to a temperature of 25.6° C. in two spiral heat exchangers connected in series, W37 (cooled to river water) and W 38 (cooled with cooling brine).

A substream of 30 311 kg/h of the cooled crude acrylic acid was conducted (pumped) into a tank. Phenothiazine was added to the residual stream of cooled crude acrylic acid in a stirred vessel, and the resulting solution which contained 1.4% by weight of phenothiazine was conducted into the liquid streams for the direct cooling in the direct coolers B34 and B35.

The crude acrylic acid had the following contents:

| | | |
|---|---|---|
| 99.771% | by wt. of | acrylic acid, |
| 0.102% | by wt. of | acetic acid, |
| 0.0094% | by wt. of | water, |
| 0.0025% | by wt. of | propionic acid, |
| 0.0245% | by wt. of | furfurals, |
| 0.0025% | by wt. of | allyl acrylate, |
| 0.0068% | by wt. of | benzaldehyde, |
| 0.0069% | by wt. of | maleic anhydride, |
| 0.0250% | by wt. of | diacrylic acid, |
| 0.0400% | by wt. of | phenothiazine, and |
| 0.0094% | by wt. of | glyoxal. |

Where columns used in this comparative example comprised sequences of valve trays, the mounting of feed weirs on these valve trays was dispensed with for reasons of contamination. Instead, the feed stream from the valve tray above was regulated by the height of the gap between the tray surface of the lower valve tray in each case and the lower edge of the downcomer, from the valve tray above. This gap width was slightly smaller than the height of the effluent weirs on the lower tray.

### Example

The procedure was as in the comparative example, except that the substream T^{Au} discharged was doubled to 520 kg/h.

In order to maintain the composition of the concentrate in the distillation unit, the liquid stream delivered to the distillation unit with the pump P9 was increased correspondingly. The same also applied to the liquid stream conveyed through the forced circulation flash evaporator W40 with the pump P40. The steam stream through W40 was likewise increased slightly. t^{V} was thus only 20.5 h.

About 24 h after the changes had been made, the glyoxal content of the crude acrylic acid withdrawn from K30 was only 0.0068% by weight of glyoxal (with substantially unchanged acrylic acid content). At the same time, the glyoxal content in the condensed vapors of the distillation amounted to only 20 ppm by weight.

A lowering of T¹ to 170° C. led to a further decrease in the glyoxal content of the crude acrylic acid conducted out of K30.

An increase of the temperature in the liquid level at the lower end of the stripping column K20 to 128° C. resulted in a further decrease in the glyoxal content of the crude acrylic acid obtained. It was thus possible to withdraw from K30 a crude acrylic acid which comprised only 30 ppm by weight of glyoxal.

The additional metering of 3000 kg/h of steam (120° C., 6 bar) into the bottom space of the absorption column meant, in contrast, an increase in the glyoxal content in the crude acrylic acid obtained.

A further attempted improvement consisted in metering 10% of additional cycle gas into the reaction gas mixture conducted into the direct cooler K9, based on the volume flow thereof, and correspondingly increasing the total gas stream conducted into the absorber as a result. The stripping action which was expected to convey glyoxal present into the acid water, however, was not established. The glyoxal content of the crude acrylic acid remained substantially unchanged as a result of this measure.

Finally, it should also be emphasized that a compound listed as a constituent for a particular stream in the comparative example was analytically no longer detectable in those streams in which it is not listed as a constituent. However, this statement does not apply to glyoxal, the content of which was not analyzed in all streams.

Alternatively to the 1.4571 material, it is always also possible to use the 1.4541 material. Otherwise, carbon steels with a strength appropriate for the particular end use were used as the material for the vapor and condensate systems. In order to prevent heat losses, the corresponding apparatuses have thermal insulation from their environment. The mounting of thermal insulation on the outer wall can also counteract undesired condensation of acrylic acid on the inner wall. Such condensate could be the starting point for undesired polymerization owing to inadequate inhibition of polymerization.

U.S. Provisional Patent Applications No. 61/222,127, filed Jul. 1, 2009, and 61/298,232, filed Jan. 26, 2010, are incorporated into the present patent application by literature reference. With regard to the abovementioned teachings, numerous changes and deviations from the present invention are possible. It can therefore be assumed that the invention, within the scope of the appended claims, can be performed differently than the way described specifically herein.

1. A process for removal of acrylic acid from the product gas mixture of a heterogeneously catalyzed partial gas phase oxidation of at least one C₃ precursor compound to acrylic acid, said product gas mixture comprising, in addition to acrylic acid, steam and glyoxal, also low boilers, medium boilers, high boilers and uncondensables other than the aforementioned compounds as secondary constituents,
in which
the product gas mixture is cooled in a direct cooler by direct cooling with a finely sprayed cooling liquid, which evaporates a portion of the cooling liquid,
the cooled product gas mixture together with evaporated and unevaporated cooling liquid is conducted into the bottom space of an absorption column, said bottom space being connected to the absorption space which is above it in the absorption column and has separating internals by a chimney tray K which is present between the two and has at least one chimney, from which
the cooled product gas mixture and evaporated cooling liquid flow through the at least one chimney of the chimney tray K into the absorption space and ascend therein in countercurrent to a high-boiling absorbent which descends therein, in the course of which adsorbate A comprising acrylic acid absorbed in the absorbent accumulates on the chimney tray K,
adsorbate A which comprises acrylic acid absorbed in the absorbent and accumulates on the chimney tray K is conducted therefrom out of the absorption column,
a portion of adsorbate A conducted out of the absorption column is fed to the bottom space of the absorption column to form a bottoms liquid present in the bottom space, and, optionally, another portion of the adsorbate A is cooled and recycled into the absorption column above the chimney tray K,
optionally, low boilers are stripped out of the remaining residual amount R^{A} of adsorbate A conducted out of the absorption column in a stripping unit to obtain an adsorbate A* depleted in low boilers,
the residual amount R^{A} of adsorbate A or the adsorbate A* is fed to a rectification column with a rectifying section and stripping section,
in the stripping section of the rectification column, the absorbent is enriched, and absorbent is conducted out of the stripping section with a proportion by weight of acrylic acid of ≦1% by weight, and
in the rectifying section of the rectification column, the acrylic acid is enriched, and a crude acrylic acid with a proportion by weight of acrylic acid of ≧90% by weight is conducted out of the rectifying section,
bottoms liquid comprising absorbent is withdrawn from the bottom space of the absorption column, a portion of this withdrawn bottoms liquid is fed to the direct cooler as cooling liquid and the residual amount of this withdrawn bottoms liquid is fed to a distillation unit which comprises a distillation column and a circulation heat exchanger,
in the distillation column, the bottoms liquid fed to the distillation unit is separated by distillation into vapor in which the proportion by weight of absorbent is greater than the proportion by weight of absorbent in the bottoms liquid, and into liquid concentrate in which the proportion by weight of constituents B with higher boiling points than the absorbent is greater than the proportion by weight of constituents B in the bottoms liquid,
a stream of the vapors, optionally after cooling and/or condensation thereof in an indirect heat exchanger, is recycled into the absorption column above the chimney tray K,
at the lower end of the distillation column, a stream M of the concentrate which accumulates there in liquid form at a level S is conducted out of the distillation column with the temperature T¹,
a substream T^{Au} of this stream M is discharged from the process for removal of acrylic acid from the product gas mixture, and
the residual stream R^{M} of the stream M is recycled into the distillation column via the circulation heat exchanger with the temperature T²≧T¹ above the withdrawal of the stream M from the distillation column,
wherein the mean residence time t^{V} of the constituents of the substream T^{Au} in the distillation unit is ≦40 h.

2. The process according to claim 1, wherein the circulation heat exchanger of the distillation unit is a forced circulation flash evaporator.

3. The process according to claim 1 or 2, wherein the product gas mixture of the partial gas phase oxidation, based on the molar amount of acrylic acid present therein, comprises ≧1 molar ppm of glyoxal.

4. The process according to claim 1 or 2, wherein the product gas mixture of the partial gas phase oxidation, based on the molar amount of acrylic acid present therein, comprises ≧10 molar ppm of glyoxal.

5. The process according to claim 1 or 2, wherein the product gas mixture of the partial gas phase oxidation, based on the molar amount of acrylic acid present therein, comprises ≧100 molar ppm of glyoxal.

6. The process according to any of claims 1 to 5, wherein the C₃ precursor compound is propylene, propane, glycerol and/or acrolein.

7. The process according to any of claims 1 to 6, wherein the boiling point of the absorbent at standard pressure is at least 20° C. above the boiling point of acrylic acid at the same pressure.

8. The process according to any of claims 1 to 6, wherein the boiling point of the absorbent at standard pressure is at least 50° C. above the boiling point of acrylic acid at the same pressure and at ≦300° C.

9. The process according to any of claims 1 to 8, wherein the absorbent is a mixture of 75 to 99.9% by weight of diphyl and 0.1 to 25% by weight of dimethyl phthalate.

10. The process according to any of claims 1 to 9, wherein T¹≧100° C.

11. The process according to any of claims 1 to 9, wherein T¹≧150° C.

12. The process according to any of claims 1 to 9, wherein T¹≧170° C. and ≦220° C.

13. The process according to any of claims 1 to 11, wherein T¹≦300° C.

14. The process according to any of claims 1 to 13, wherein T² is up to 50° C. above T¹.

15. The process according to any of claims 1 to 13, wherein T² is ≧1° C. and ≦15° C. above T¹.

16. The process according to any of claims 1 to 15, wherein the circulation heat exchanger is a forced circulation flash evaporator and the residual stream R^{M} recycled into the distillation column with the temperature T² via the circulation heat exchanger is recycled into the distillation column above the level S of the concentrate.

17. The process according to any of claims 1 to 16, wherein t^{V} is ≧5 h and ≦30 h.

18. The process according to any of claims 1 to 16, wherein t^{V} is ≧10 h and ≦25 h.

19. The process according to any of claims 1 to 18, wherein low boilers are stripped out of the remaining residual amount R^{A} of adsorbate A conducted out of the absorption column in a stripping column.

20. The process according to any of claims 1 to 19, wherein the content of metal ions in the bottoms liquid in the bottom space of the absorption column is ≦1 ppm by weight per metal type.

21. The process according to any of claims 1 to 20, wherein the content of Cr, Co, Cd, Fe, Mn, Mo, Ni, Sn, V, Zn, Zr, Ti, Sb, Bi, P, Al, Ca, Mg, K and Li in the bottoms liquid in the bottom space of the absorption column is ≦1 ppm by weight per metal mentioned.

22. The process according to any of claims 1 to 21, wherein the crude acrylic acid is conducted out of the rectifying section of the rectification column with a proportion by weight of acrylic acid of ≧95% by weight.

23. The process according to any of claims 1 to 22, wherein the top pressure in the distillation column of the distillation unit is 10 to 250 mbar.

24. The process according to any of claims 1 to 23, wherein the absorbent conducted out of the stripping section of the rectification column with an acrylic acid content of ≦1% by weight is recycled into the process for removal of acrylic acid from the product gas mixture of the gas phase partial oxidation.
